(19) United States
(12) Patent Application Publication
(10) Pub. No.: US 2025/0173096 A1
(43) Pub. Date: May 29, 2025

(54) APPLICATION, AND CONTROL METHOD AND INFORMATION PROCESSING APPARATUS TO BE IMPLEMENTED BY THE APPLICATION

(71) Applicant: CANON KABUSHIKI KAISHA, Tokyo (JP)

(72) Inventor: KINYA HONDA, Chiba (JP)

(21) Appl. No.: 18/962,668

(22) Filed: Nov. 27, 2024

(30) Foreign Application Priority Data
Nov. 29, 2023 (JP) 2023-201642

(51) Int. Cl. G06F 3/12

(52) U.S. Cl. CPC G06F 3/1206; G06F 3/1228; G06F 3/1245; G06F 3/1246; G06F 3/1287; G06F 3/1288

(57) ABSTRACT

A non-transitory computer-readable storage medium stores an application program which causes an information processing apparatus to perform a control method, the application program being configured to support a general-purpose printer driver stored in the information processing apparatus, the control method including setting a setting value of a first function which transmits a file of a predetermined format output by a document generation application to a printing apparatus without converting the format of the file, setting a setting value of a second function which prints information appended with use of a predetermined function provided by the document generation application, and, in a case where the first function has been set enabled, causing print data generated based on the set setting value of the second function to be transmitted.

### BACKGROUND

### Field of the Disclosure

Aspects of the present disclosure generally relate to an application and a control method and an information processing apparatus which are to be implemented by the application.

### Description of the Related Art

Recently, there has been proposed a “general-purpose printer driver (local printer driver)”, which performs printing and communication using an industry-standard protocol such as the Internet Printing Protocol (IPP). Moreover, there also has been proposed a “general-purpose printer driver (cloud printer driver)”, which communicates with a cloud print server. The “general-purpose printer driver” is able to communicate with printers provided by a plurality of types of printer vendors. The user is allowed to, without having to install a vendor-specific printer driver, carry out printing by transmitting print data to a printer or a cloud print server connected to, for example, a personal computer (PC).

Conventionally, in the case of printing using the “general-purpose printer driver”, a file which is output by an application is once XPS®-converted into the “Extensible Markup Language (XML) Paper Specification (XPS) format”. Then, the file converted into the XPS format is PDF-converted into the “Portable Document Format (PDF)” format and is then transmitted to a printer, such as discussed in Japanese Patent Application Laid-Open No. 2020-46741.

On the other hand, among applications which run in PCs, there are applications which output files of the PDF format. It has been proposed to, in the case of using such an application and using a general-purpose printer driver, directly transmit, for example, a PDF-format file which is output by the application to a printer.

On the other hand, a predetermined application which outputs a PDF-format file is provided with a function which allows selecting whether to print an annotation (comment) or form in PDF at the time of printing a PDF-format file. Examples of applications each of which prints a PDF-format file include Acrobat DC developed by Adobe Inc. A print dialog which Acrobat DC displays is available to select whether to print only “document” in PDF or whether to print “document and annotation” or “document and form” in PDF. This function is used for such a purpose that, for example, in a case where a text annotation is present as a note in PDF, the user would like not to print the note at the time of printing.

The function of generating, for use in printing, data obtained by appending an annotation or form to a document is provided by an application which treats a file of the PDF format, such as Acrobat DC. The application uses the Graphics Device Interface (GDI) to convert data used for printing a document, annotation, and form generated by the application and then transmits a drawing command to a general-purpose printer driver. Based on the received drawing command, the general-purpose printer driver creates a file of the XPS format including a document, annotation, and form with use of the function of an operating system (OS).

The setting value for the function of allowing selecting whether to print an annotation or form in PDF is still not communicated to a printing apparatus, so that a system which directly transmits a file of the PDF format output by the application to the printing apparatus for printing is not able to use such a function.

### SUMMARY

Embodiments of the present disclosure are generally directed to enabling the user to carry out desired printing.

According to embodiments of the present disclosure, a non-transitory computer-readable storage medium stores an application program which causes an information processing apparatus to perform a control method, the application program being configured to support a general-purpose printer driver stored in the information processing apparatus, the control method including setting a setting value of a first function which transmits a file of a predetermined format output by a document generation application to a printing apparatus without converting the format of the file, setting a setting value of a second function which prints information appended with use of a predetermined function provided by the document generation application, and, in a case where the first function has been set enabled, causing print data generated based on the set setting value of the second function to be transmitted.

Further features of the present disclosure will become apparent from the following description of exemplary embodiments with reference to the attached drawings.

### BRIEF DESCRIPTION OF THE DRAWINGS

FIG. 1 is a configuration diagram of a printing system according to a first exemplary embodiment of the present disclosure.

FIGS. 2A, 2B, and 2C are configuration diagrams of a client terminal, a cloud print server, and a cloud print compatible printer, respectively, which constitute the printing system according to the first exemplary embodiment.

FIGS. 3A and 3B are sequence diagrams illustrating processing operations starting with “print setting” and ending with “print data transmission” in a print setting enhancement application in the first exemplary embodiment.

FIG. 4 is an explanatory diagram of an example of a print setting initial screen which a document generation application displays.

FIG. 5 is an explanatory diagram of “capability information” about the cloud print compatible printer.

FIGS. 6A and 6B are explanatory diagrams of switching of a print setting screen of a print support application (PSA) and a printer driver in a case where print data is other than a PDF file or an image forming apparatus does not have a PDF processing capability in the client terminal.

FIGS. 7A, 7B, 7C, and 7D are explanatory diagrams of examples of a print setting screen which is displayed in a case where the print setting enhancement application is still not installed.

FIGS. 8A, 8B, 8C, 8D, 8E, and 8F are explanatory diagrams of examples of a print setting screen which is displayed in a case where the print setting enhancement application is currently installed.

FIGS. 9A, 9B, and 9C are explanatory diagrams of examples of a PDF passthrough setting screen which the cloud print compatible printer displays.

FIG. 10 is a flowchart illustrating processing which the client terminal performs in the first exemplary embodiment.

FIG. 11 is a flowchart illustrating processing which the client terminal performs in the first exemplary embodiment (following the flowchart illustrated in FIG. 10).

FIG. 12 is a flowchart illustrating processing which the cloud print compatible printer performs in the first exemplary embodiment.

FIG. 13 is a sequence diagram illustrating processing operations starting with “print setting” and ending with “print data transmission” in a print setting enhancement application in a second exemplary embodiment of the present disclosure.

FIG. 14 is a flowchart illustrating processing which the client terminal performs in the second exemplary embodiment.

FIG. 15 is a sequence diagram illustrating processing operations starting with “print setting” and ending with “print data transmission” in a print setting enhancement application in a third exemplary embodiment of the present disclosure.

FIG. 16 is a flowchart illustrating processing which the client terminal performs in the third exemplary embodiment.

FIG. 17 is a flowchart illustrating processing which the client terminal performs in a fourth exemplary embodiment of the present disclosure.

FIG. 18 is a sequence diagram illustrating processing operations starting with “print setting” and ending with “print data transmission” in a print setting enhancement application in a fifth exemplary embodiment of the present disclosure.

FIG. 19 is a flowchart illustrating processing which the client terminal performs in the fifth exemplary embodiment.

FIG. 20 is a sequence diagram illustrating processing operations starting with “print setting” and ending with “print data transmission” in a print setting enhancement application in a sixth exemplary embodiment of the present disclosure.

FIG. 21 is a flowchart illustrating processing which the client terminal performs in the sixth exemplary embodiment.

### DESCRIPTION OF THE EMBODIMENTS

Various exemplary embodiments, features, and aspects of the disclosure will be described in detail below with reference to the drawings. However, various configurations described in the following exemplary embodiments are merely examples, and the scope of the disclosure should not be construed to be limited by the exemplary embodiments. In the present specification, a print setting application for enhancing the print setting function of a standard driver installed in the operating system (OS) of a client terminal 101 is referred to as a “print setting enhancement application”. Moreover, a “general-purpose printer driver” may be also referred to as a “standard driver”.

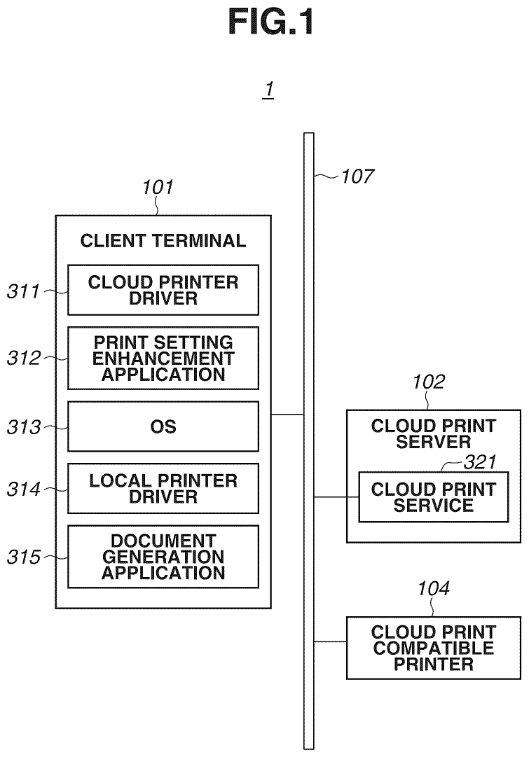

### FIG. 1: System Configuration

FIG. 1 is a configuration diagram of a printing system 1 according to a first exemplary embodiment of the present disclosure. The printing system 1 is a system capable of performing cloud print. The printing system 1 includes a client terminal 101, a cloud print server 102, and a cloud print compatible printer 104. These elements are connected to a network 107 in such a way as to be able to communicate required pieces of information to each other.

While, in FIG. 1, only one client terminal 101 and only one cloud print compatible printer 104 are illustrated, a plurality of client terminals 101 or a plurality of cloud print compatible printers 104 can be provided. Moreover, the cloud print server 102 can be configured with a plurality of information processing apparatuses. Moreover, the cloud print server 102 can be contained in a server system configured with a plurality of information processing apparatuses for the purpose of load distribution.

Moreover, the cloud print server 102 can be virtually configured inside a physically single information processing apparatus. While the network 107 is assumed to be a wide area network (WAN), such as the Internet, in such a way as to enable providing a cloud service, the entirety of the network 107 can be located under a closed communication environment such as an internal (in-house) local area network (LAN).

On the client terminal 101, a cloud printer driver 311, a print setting enhancement application 312, and a local printer driver 314 are installed in an OS 313 illustrated in FIG. 1. The client terminal 101 is an information processing apparatus, such as a personal computer (PC), a tablet, or a smartphone, and is a terminal which the user is able to directly operate. The client terminal 101 is configured to allow required pieces of application software to be executed on the OS 313 or middleware. The cloud printer driver 311 is a printer driver manufactured by a provider for a cloud print service, and is a driver previously installed in the OS 313.

The cloud print compatible printer 104 is a printing apparatus which actually performs printing on a recording medium such as paper. For example, the cloud print compatible printer 104 is an image forming apparatus (multifunction peripheral (MFP)) which includes a printing function for converting print data received via the network 107 into image data and printing the image data, a facsimile function, and a copying function. The cloud print compatible printer 104 is able to receive, via the cloud print server 102, print data transmitted from the client terminal 101.

Additionally, the cloud print compatible printer 104 is able to receive print data from the client terminal 101 directly without via the cloud print server 102.

The cloud print compatible printer 104 receives, via the cloud print server 102, print data generated by the cloud printer driver 311, which is installed on the client terminal 101, thus performing printing. Moreover, the cloud print compatible printer 104 is also able to receive, without via the cloud print server 102, print data generated by the local printer driver 314, which is installed on the client terminal 101, thus performing printing. The local printer driver 314 is a printer driver which is provided by a vendor (manufacturer) which provides the OS 313, and is a printer driver previously incorporated in the OS 313.

The cloud print server 102 includes a cloud print service 321. The cloud print service 321 receives a print instruction and print data from an external unit. Then, the cloud print server 102 transmits the received print data to the cloud print compatible printer 104, which is designated by the print data. Furthermore, in the first exemplary embodiment, image data and print setting information are collectively referred to as “print data”.

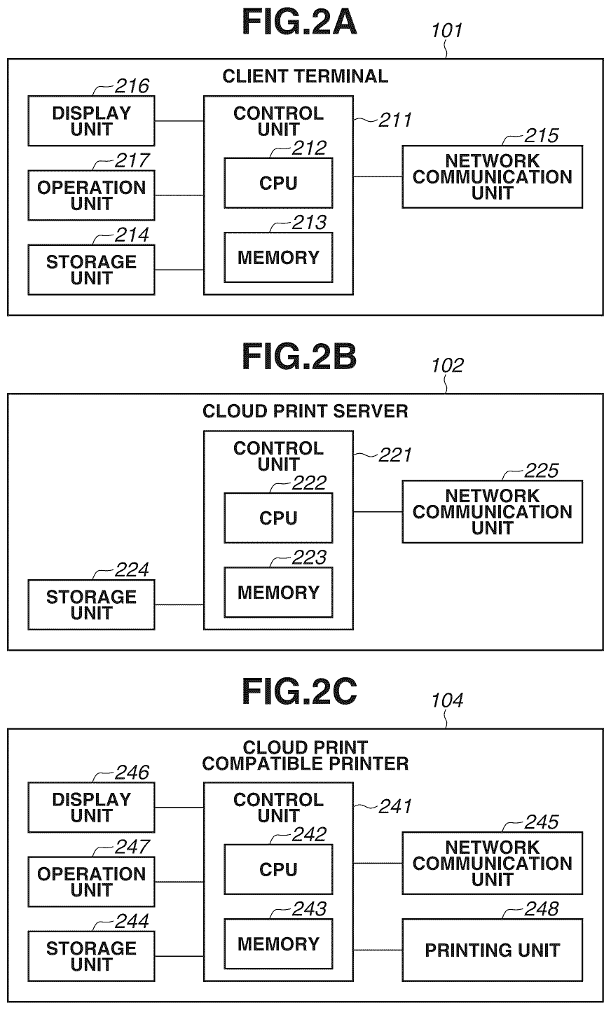

Next, configurations of the client terminal 101, the cloud print server 102, and the cloud print compatible printer 104 in the printing system 1 according to the first exemplary embodiment are described with reference to FIGS. 2A, 2B, and 2C, respectively.

FIG. 2A is a configuration diagram of the client terminal 101. The client terminal 101 includes a display unit 216, an operation unit 217, a storage unit 214, a control unit 211, and a network communication unit 215. The display unit 216 is a display device such as a liquid crystal display, and displays visually recognizable information to the user. The operation unit 217 is an input device for receiving an input from the user, such as a keyboard and a mouse. The storage unit 214 is a storage device which stores data in rewritable and non-volatile manners, such as a hard disk, solid state drive (SSD), or flash memory. Furthermore, a device which includes both functions of the display unit 216 and the operation unit 217, such as a touch panel, can be employed.

The control unit 211 includes a central processing unit (CPU) 212 and a memory 213, and controls the entire operation of the client terminal 101. The CPU 212 loads a program stored in the storage unit 214 onto the memory 213 and executes the loaded program. The memory 213 is a main storage memory for the CPU 212, and includes a work area and a temporary storage region for loading various programs thereon.

The network communication unit 215 performs transmission and reception of data with an external server (the cloud print server 102) and the cloud print compatible printer 104 via the network 107.

FIG. 2B is a configuration diagram of the cloud print server 102. The cloud print server 102 includes a storage unit 224, a control unit 221, and a network communication unit 225. The storage unit 224, the control unit 221, and the network communication unit 225 are equivalent to the respectively corresponding ones of the client terminal 101, and are, therefore, omitted from description.

Furthermore, while, in the first exemplary embodiment, the cloud print server 102 is configured with a single information processing apparatus as illustrated in FIG. 2B, the cloud print server 102 can be a server system configured with a plurality of information processing apparatuses. In the storage unit 224 of the cloud print server 102, programs for various services which the cloud print server 102 itself provides are stored. These programs are loaded onto a memory 223 at the time of start-up of the cloud print server 102, and the loaded program are executed by a CPU 222, so that the cloud print service 321 is implemented.

FIG. 2C is a configuration diagram of the cloud print compatible printer 104. The cloud print compatible printer 104 includes a display unit 246, and an operation unit 247, a storage unit 244, a control unit 241, a network communication unit 245, and a printing unit 248. The display unit 246 is a display device for displaying information in a manner visually recognizable by the user, such as a touch panel or a light-emitting diode (LED), provided at the cloud print compatible printer 104. The operation unit 247 is an input device for receiving an input from the user, and may include, in addition to a touch-operable touch panel, hardware keys such as a numeric keypad. The storage unit 244 and the control unit 241 are equivalent to the respectively corresponding ones of the client terminal 101 and are, therefore, omitted from description.

The network communication unit 245 is configured to perform communication with the external network 107. The network communication unit 245 mainly performs reception of print data, but has also the function of transmitting information indicating the status of the network communication unit 245 itself, such as error information, to an external server. The printing unit 248 performs print processing by performing a series of operations for paper feeding, printing, and paper discharging with respect to a sheet of paper serving as a print medium prepared in a cassette or tray. The printing method is, for example, an electrophotographic method or an inkjet method, and is not particularly limited. The printing unit 248 also includes a duplex (double-sided) printing unit and a finishing device for, for example, stapling and punching, which are used at the time of discharging of paper. Furthermore, while, in the first exemplary embodiment, as an example of the cloud print compatible printer 104, a single function printer for executing only a printing function is described, a multifunction peripheral (MFP) which has a plurality of functions can be employed.

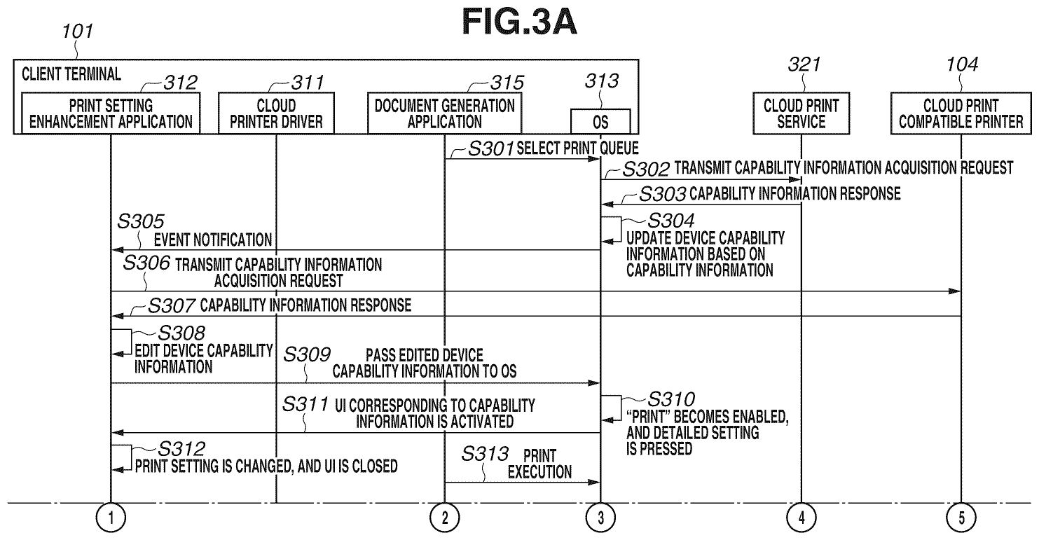

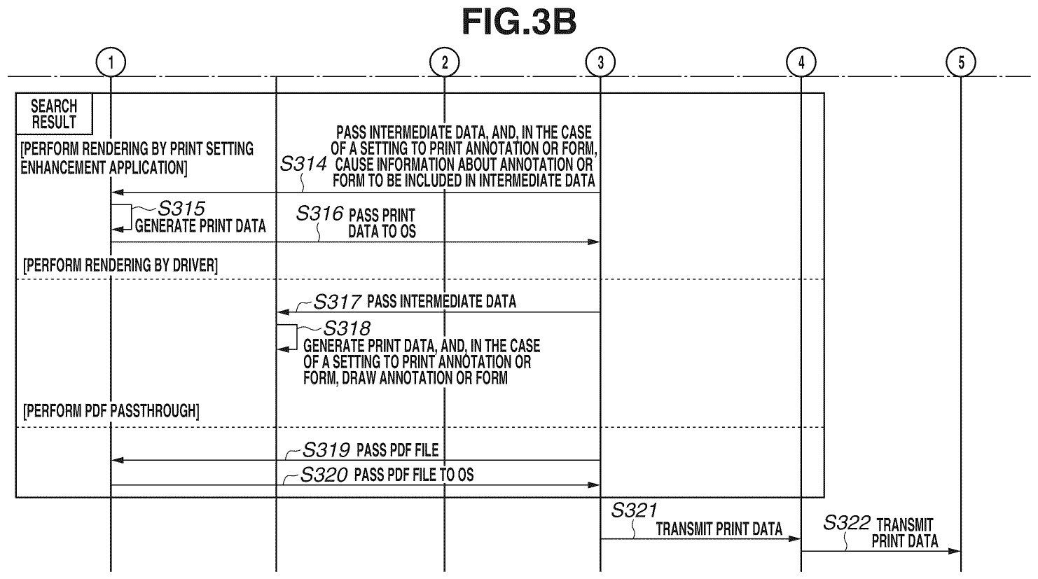

Next, processing operations starting with “print setting” and ending with “print data transmission” in the print setting enhancement application 312 are described with reference to FIGS. 3A and 3B.

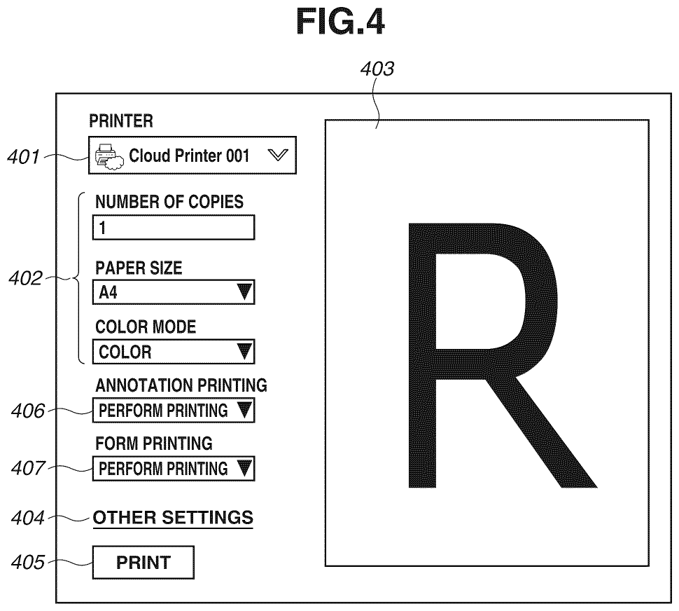

A document generation application 315 displays, as a print setting initial screen, a print setting screen (illustrated in FIG. 4) for performing selection of a print queue on the display unit 216. Furthermore, the document generation application 315 is an application for document file generation, such as a creation application for document data, a creation application for presentation materials, or a display application for photographs or image data.

In the first exemplary embodiment, the document generation application 315 displays a print setting initial screen on the display unit 216. As illustrated in FIG. 4, in the print setting initial screen, an object 401 for selecting a printer, an object 402 for print setting, and a print preview 403 are displayed. Moreover, in the print setting initial screen, an object 404 for other settings and a print button 405 are also displayed.

Additionally, in the print setting initial screen, “annotation printing” 406 for setting whether to print an annotation in PDF and “form printing” 407 for setting whether to print a form in PDF are also displayed. An annotation in PDF functions to associate an object such as a memorandum with content on a page in PDF. A variety of annotation types, such as a text annotation, are prepared for PDF. Moreover, a form in PDF is an aggregation of fields. The fields are used to collect information through dialogue with the user. For example, the fields include a button field such as a checkbox, a text field for inputting text, and a selection field such as a list box.

Furthermore, while, in the first exemplary embodiment, the document generation application 315 displays a print setting initial screen, the OS 313 can be configured to perform displaying of a print setting initial screen.

First, in step S301, the document generation application 315 communicates information about a print queue selected by the user via the object 401 to the OS 313. Specifically, the document generation application 315 transmits selection information about a print queue to the OS 313. Furthermore, it is assumed in the description that, at the timing when displaying of the print setting initial screen has been started, a print queue for a default printer is previously selected.

Next, in step S302, the OS 313 transmits a “capability information acquisition request” for acquiring “capability information” about the printer to the cloud print service 321. The OS 313 transmits the “capability information acquisition request” to the cloud print service 321 while designating a printer name selected via the object 401 in the print setting initial screen.

An inquiry is made at the cloud print service 321, which registers the cloud print compatible printer 104, with use of, for example, a standard protocol defined by the “Internet Printing Protocol (IPP)”, such as “Get-printer-Attributes”. In a case where “Get-printer-Attributes” is used, an inquiry about “capability information” which is currently set by the OS 313 is made in list form.

Next, in step S303, the cloud print service 321 transmits, as a response, “capability information” about the cloud print compatible printer 104, obtained by referring to a list of “capability information” sent with “Get-printer-Attributes”, to the OS 313. In FIG. 3A, this transmission is referred to as “capability information response”. For example, it is assumed that an “attribute value” of the media size has been designated with “Get-printer-Attributes (IPP)”.

Then, in a case where the cloud print service 321 has an “attribute value” of the media size, the cloud print service 321 transmits, as a response, a value associated with the “attribute value” (such as “A4”, “B5” or “Letter”). On the other hand, in a case where the “attribute value” designated with “Get-printer-Attributes” is not present in a queue for the cloud print compatible printer 104 of the cloud print service 321, the cloud print service 321 does not transmit, as a response, the associated value.

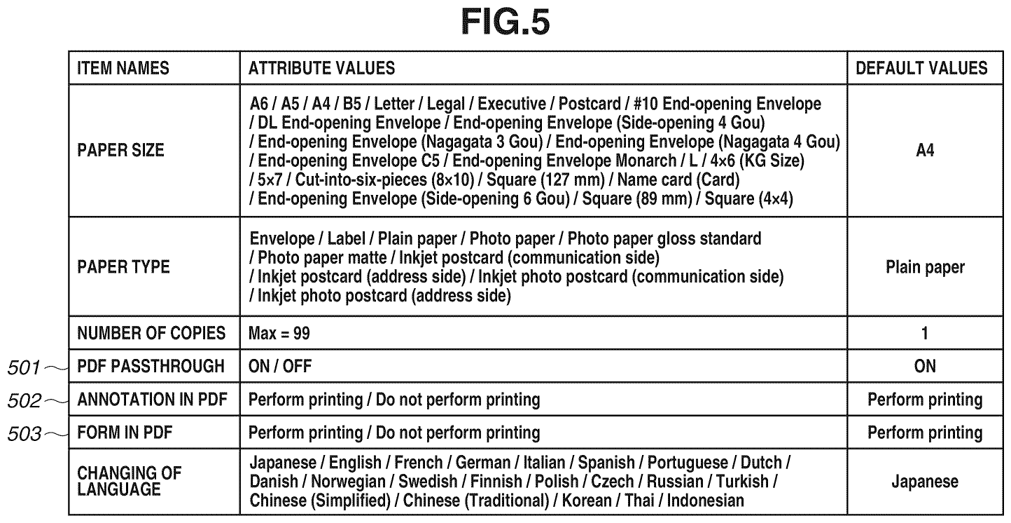

Here, the capability information which is acquired by processing operations in step S302 and step S303 is described with reference to FIG. 5. FIG. 5 illustrates capability information about the cloud print compatible printer 104 which is currently registered with the cloud print server 102.

In the first exemplary embodiment, by using the “IPP” as a communication protocol for communications of “capability information”, the cloud print service 321 acquires “item names”, “attribute values”, and “default values” such as those illustrated in FIG. 5 from the cloud print compatible printer 104. The “item names” are equivalent to setting items of print setting information, the “attribute values” are equivalent to options or setting value ranges in the respective setting items, and the “default values” are equivalent to setting values. Moreover, the “item names” and “attribute values” stored in the cloud print compatible printer 104 include information defined as industry standard specifications by the “IPP” and information uniquely defined by a printer vendor.

In the capability information illustrated in FIG. 5, “PDF passthrough” 501, “annotation in PDF” 502, and “form in PDF” 503 are vendor-specific setting items.

The “PDF passthrough” 501 is capability information about the function of setting whether to use a function of performing printing without converting a “PDF” file generated by the document generation application 315 into “XPS®” (PDF passthrough). The value “ON” indicates being enabled, and the value “OFF” indicates being disabled. In a case where “PDF passthrough” is set disabled, the application invokes “Application Programming Interface (API)” prepared by the OS 313. Then, the OS 313 converts a PDF file targeted for printing into the XPS file format, and passes the XPS data to the cloud printer driver 311.

The “annotation in PDF” 502 is capability information about the function of switching, with the cloud print compatible printer 104, whether to print an annotation in PDF. Similarly, the “form in PDF” 503 is capability information about the function of switching, with the cloud print compatible printer 104, whether to print a form in PDF.

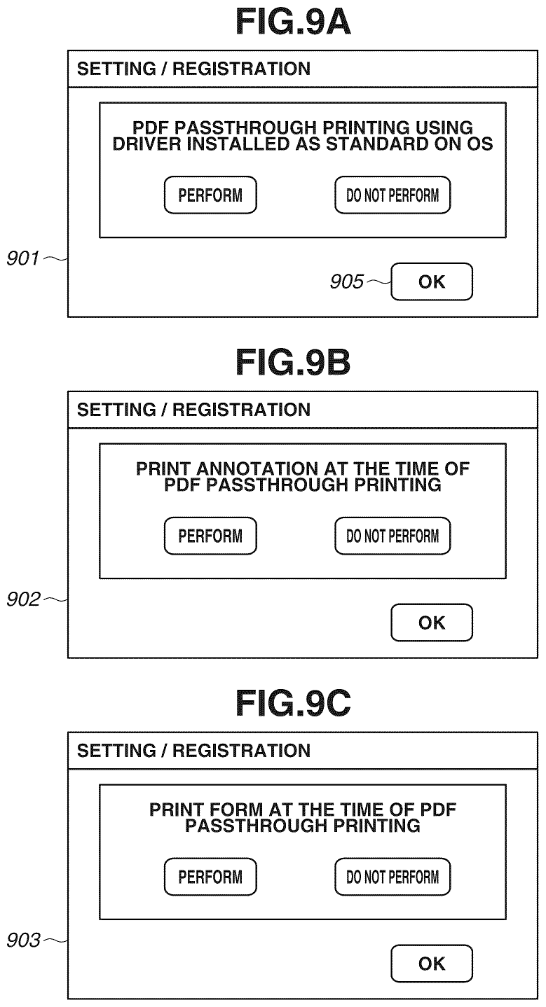

Here, the method of setting default values of the vendor-unique capability information which is registered with the cloud print server 102 is described with reference to FIGS. 9A, 9B, and 9C. FIGS. 9A to 9C illustrate setting screens each of which is displayed on the display unit 246 of the cloud print compatible printer 104.

A screen 901 is a screen for setting a default value of the function of PDF passthrough printing in using a printer driver installed as standard on the OS 313. In a case where a button for “PERFORM” has been selected, the cloud print compatible printer 104 sets the default of PDF passthrough printing to “ON”. In a case where a button for “DO NOT PERFORM” has been selected, the cloud print compatible printer 104 sets the default of PDF passthrough printing to “OFF”. The set default value of the setting “PDF passthrough” 501 is communicated to the client terminal 101 via the cloud print server 102. Furthermore, the printer driver installed as standard on the OS 313 refers to the local printer driver 314 or the cloud printer driver 311.

A screen 902 is a screen for setting a default value of the annotation printing function at the time of PDF passthrough printing. In a case where a button for “PERFORM” has been selected, the cloud print compatible printer 104 sets the default of the annotation printing function in PDF at the time of use of PDF passthrough to “PERFORM PRINTING”. In a case where a button for “DO NOT PERFORM” has been selected, the cloud print compatible printer 104 sets the default of the annotation printing function in PDF at the time of use of PDF passthrough to “DO NOT PERFORM PRINTING”.

A screen 903 is a screen for setting a default value of the form printing function at the time of PDF passthrough printing. In a case where a button for “PERFORM” has been selected, the cloud print compatible printer 104 sets the default of the form printing function in PDF at the time of use of PDF passthrough to “PERFORM PRINTING”. In a case where a button for “DO NOT PERFORM” has been selected, the cloud print compatible printer 104 sets the default of the form printing function in PDF at the time of use of PDF passthrough to “DO NOT PERFORM PRINTING”.

Furthermore, while, in the first exemplary embodiment, an example of performing setting with use of a setting screen which is displayed on the printer body has been described, a configuration in which setting is able to be performed in the client terminal 101 via the network 107 without an operation being performed on the printer body. Furthermore, a printer vendor-unique “attribute value” can be defined as an “attribute value” corresponding to an “item name” defined as industry standard specifications. Additionally, the “capability information” is information indicating functions installed on the printers irrespective of whether the “item name” and “attribute value” are defined by the IPP.

In step S303, in the capability information illustrated in FIG. 5, pieces of capability information which are defined by the IPP are acquired.

Next, in step S304, the OS 313 updates “device capability information” based on the “capability information” acquired from the cloud print service 321. In a case where the “device capability information” has been updated, by performing updating processing in step S304, the OS 313 is able to update “device capability information” which the client terminal 101 manages.

Next, in step S305, the OS 313 communicates “event” and “API” which is used for editing of device capability information to the print setting enhancement application 312.

In response to receiving the “event”, the print setting enhancement application 312 transmits an acquisition request for “capability information” to the cloud print service 321. In FIG. 3A, this transmission is referred to as “capability information acquisition”. The acquisition of “capability information” which is performed here is performed to write the “setting item” and “attribute value” which are uniquely defined by a printer vendor into “device capability information”.

Next, in step S306, in response to receiving an editing event for “device capability information” from the OS 313, the print setting enhancement application 312 inquires of the cloud print service 321 about capability information about the cloud print compatible printer 104. In FIG. 3A, this inquiry is referred to as “capability information acquisition”. At this time, the print setting enhancement application 312 inquires of the cloud print service 321 and thus reads “capability information” including the setting “PDF passthrough” 501 (see FIG. 5) which is stored in the cloud print compatible printer 104.

This inquiry is made with use of “Get-printer-Attributes” as with a processing operation in step S302 illustrated in FIG. 3A, and the print setting enhancement application 312 acquires “capability information” by designating an “item name” of the setting item targeted for inquiry. Furthermore, the acquisition target for “capability information” in step S306 is not limited to the “setting item” and “attribute value” uniquely defined by a printer vendor, but can be “setting items” previously acquired by the OS 313.

Next, in step S307, the cloud print service 321 transmits a response to the print setting enhancement application 312. In FIG. 3A, this transmission is referred to as “capability information response”. In the first exemplary embodiment, the “capability information” to be transmitted as a response in step S307 is “capability information” about the cloud print compatible printer 104 which the cloud print service 321 stores in the storage unit 224 (see FIG. 2B).

In this way, by executing step S306 and step S307, the client terminal 101 is able to acquire vendor-unique capability information written in the settings 501 to 503 illustrated in FIG. 5.

Next, in step S308, the print setting enhancement application 312 edits the “device capability information” via a “configuration information object”, which is a data group required for editing the “device capability information”. For example, the print setting enhancement application 312 converts the “capability information” written in the settings 501 to 503 illustrated in FIG. 5 acquired in step S307 illustrated in FIG. 3A into “device capability information” and adds the “device capability information” to the “configuration information object”. In this way, the print setting enhancement application 312 edits the “device capability information”. As a result of the editing, “capability information” concerning standard “setting items” acquired by an inquiry by the OS 313 is added to the “device capability information”. This causes the vendor-unique “setting items” and “attribute values” including the settings “PDF passthrough” 501, “annotation in PDF” 502, and “form in PDF” 503 to be stored in the storage unit 214.

Next, in step S309, the print setting enhancement application 312 sends the edited “device capability information” to the OS 313. The OS 313 stores the “device capability information” acquired from the print setting enhancement application 312 in the storage unit 214 while associating the “device capability information” with a print queue. Next, in step S310, the OS 313 updates the “device capability information”, so that an object serving as a trigger for displaying a user interface (UI) of the print setting enhancement application 312, such as the object 404 (FIG. 4), comes into the state of being selectable. Furthermore, until the processing operation in step S310 is completed, the object 404 is in the state of being grayed out.

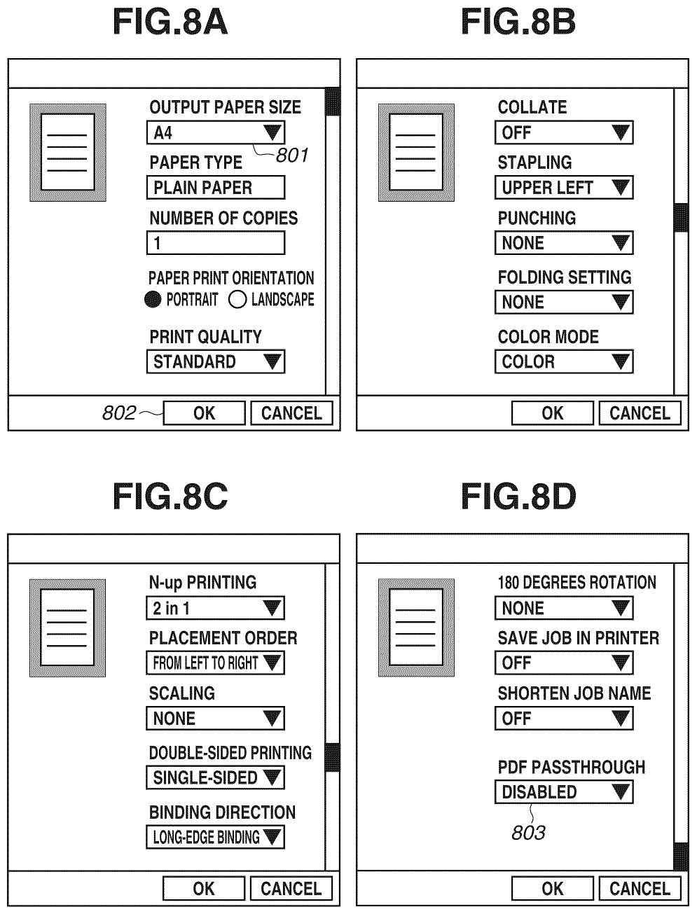

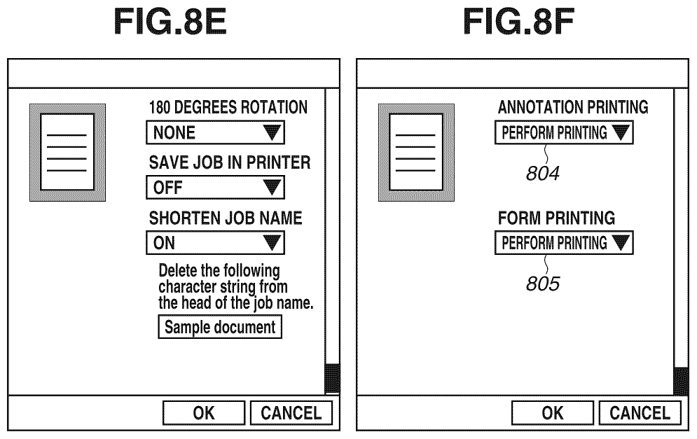

Then, in step S311, in response to the user selecting the object 404, the OS 313 activates the print setting enhancement application 312 to display a print setting screen such as that illustrated in FIG. 8A on the display unit 216. In step S311, a UI corresponding to the “capability information” is activated. As a result, a UI in which the device settings have been reflected is displayed. Thus, the OS 313 includes a UI unit which displays, in a display screen of the display unit 216, information in which information indicating the enabled or disabled state of file conversion included in the read print setting information has been reflected. Such a print setting screen does not depend on the type of the document generation application 315 to be used.

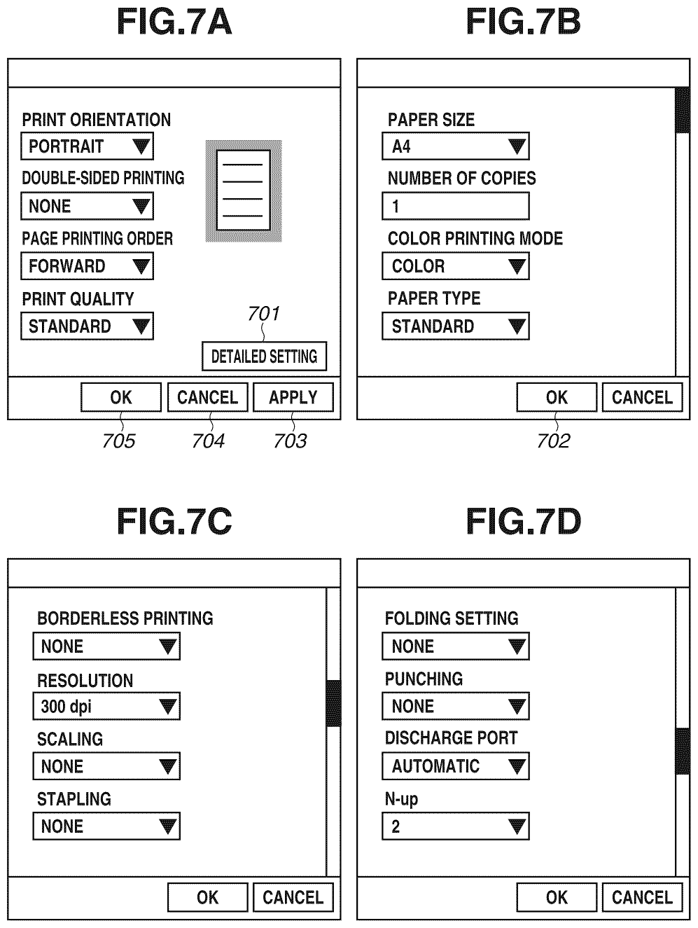

Furthermore, in a case where the print queue and the print setting enhancement application 312 are not associated with each other, a “standard print setting screen” previously installed in the OS 313 such as that illustrated in FIG. 7A is displayed. In response to a detailed setting button 701 being operated to be pressed in the “standard print setting screen”, a detailed printing screen illustrated in FIG. 7B is displayed. Thus, the detailed printing screen, which displays setting items which are not able to be completely displayed by the standard print setting screen” illustrated in FIG. 7A, is displayed. Furthermore, the detailed printing screen illustrated in FIG. 7B is a screen corresponding to a movement operation in the vertical direction of a scroll bar (SB), and displays the setting contents of a plurality of setting items supported by the OS 313 while being moved upward or downward as illustrated in FIG. 7C and FIG. 7D.

Moreover, in FIG. 7A, an apply button 703 is a button for storing the print setting, a cancel button 704 is a button for returning to the screen illustrated in FIG. 4 without storing the print setting, and an OK button 705 is a button for storing the print setting and then returning to the screen illustrated in FIG. 4. Furthermore, while, even in FIG. 7B to FIG. 7D, an OK button is displayed, the OK button illustrated in FIG. 7B is indicated by reference numeral “702”. Furthermore, in the print setting screen which is provided by the OS 313, a setting item concerning PDF passthrough is not displayed.

Here, the description refers back to the print setting enhancement application 312. The print setting enhancement application 312 receives print setting information which the OS 313 has generated based on the print setting capability information generated based on the “device capability information”, and displays the print setting information as an enhanced print setting screen such as that illustrated in FIG. 8A on the display unit 216. The screens illustrated in FIG. 8A to FIG. 8E are displayed in response to a scroll bar (SB) being operated for scrolling. The print setting enhancement application 312 displays contents indicated by the “device capability information” as setting values (attribute values) in the enhanced print setting screen.

The print setting enhancement application 312 provides the function of allowing the user to optionally change print setting. In a case where print setting has been changed, the setting value thereof is able to be stored. In response to the user selecting and operating an OK button 802 displayed in the enhanced print setting screen illustrated in FIG. 8A, the print setting is fixed. For example, suppose that the user has changed the output paper size from “A4” to “Letter” on the UI. In this case, the print setting information retained in the print setting enhancement application 312 is changed from “A4” to “Letter” in output paper size.

A list box 803 illustrated in FIG. 8D is a box used to set the enablement or disablement of a “PDF passthrough function”. The list box 803 allows “capability information” acquired by the print setting enhancement application 312 from the cloud print compatible printer 104 in step S306 to be reflected therein. In a case where the “PDF passthrough setting: 501 in FIG. 5” has been set to “ON” at the cloud print compatible printer 104, a setting screen in which the default setting of “PDF passthrough” shown in the list box 803 has been set to “ON” is presented to the user. On the other hand, in the PDF passthrough setting 501 has been set to “OFF” at the cloud print compatible printer 104, a setting screen in which the default setting of “PDF passthrough” shown in the list box 803 has been set to “OFF” is presented to the user.

In a case where the PDF passthrough is “disabled: OFF”, data of the PDF format created by the document generation application 315 is once converted into data of the XPS format by the OS 313 serving as a conversion unit, the data of the XPS format obtained by conversion is converted into data of the PDF format by the print setting enhancement application 312, and the data of the PDF format obtained by conversion is then transmitted to the cloud print server 102.

On the other hand, in a case where the PDF passthrough is “enabled”, data of the PDF format created by the document generation application 315 is transmitted to the cloud print server 102 without being converted into data of the XPS format. FIG. 8F illustrates a setting screen concerning annotation printing and form printing which are performed at the time of using the PDF passthrough function. A box 804 is displayed based on the setting 502 illustrated in FIG. 5. A box 805 is displayed based on the setting 503 illustrated in FIG. 5. Furthermore, in a case where the list box 803 is currently set to “disabled”, these two setting items are grayed out in such a way as to be unable to be set. Furthermore, in the first exemplary embodiment, it is assumed that the settings 804 and 805 illustrated in FIG. 8F are setting items which are set independently of the settings 406 and 407 illustrated in FIG. 4.

In step S312, in response to the OK button 802 being selected and operated by the user, the print setting enhancement application 312 acquires, from the print setting screen, “print setting information” set via the print setting screen, passes the acquired print setting information to the OS 313, and then closes the enhanced print setting screen illustrated in FIG. 8A. Then, upon the completion of the processing operation in step S312, the print setting enhancement application 312 displays the print setting initial screen illustrated in FIG. 4 in which the setting values set by the print setting enhancement application 312 have been reflected.

Next, in step S313, in response to the user pressing and operating the print button 405 in the print setting initial screen illustrated in FIG. 4, a print instruction is input to the OS 313. The OS 313 performs print processing based on the input instruction (print execution).

In the print setting initial screen illustrated in FIG. 4, with regard to processing which is performed when the user selects and operates the print button 405, the following “three patterns” are assumed. The “first pattern” is a case where the print setting enhancement application 312 which is associated with a currently selected print queue is previously installed on the client terminal 101 and the setting of the PDF passthrough function is currently set to “disabled”. The “second pattern” is a case where the print setting enhancement application 312 which is associated with a currently selected print queue is not currently installed. Then, the “third pattern” is a case where the print setting enhancement application 312 which is associated with a currently selected print queue is previously installed and the setting of the PDF passthrough function is currently set to “enabled”. The three patterns are described below one by one.

The first pattern is a case where the print setting enhancement application 312 which is associated with a print queue is previously installed on the client terminal 101 and the PDF passthrough function is currently set to “disabled”. In step S314, the OS 313 generates intermediate data from image data which the document generation application 315 has output. The OS 313 sends the intermediate data and the print setting information to the print setting enhancement application 312 via the cloud printer driver 311.

The “intermediate data” is, for example, data of the XPS format, and, specifically, “print capability information” refers to an “attribute value” which is defined by the IPP from the print setting information.

Moreover, in a case where, in a print setting initial screen illustrated in FIG. 4 which the document generation application 315 displays, the “annotation printing” 406, which is used to set whether to print an annotation in PDF, is currently set to “perform printing”, the document generation application 315 also outputs an annotation. In a case where the “annotation printing” 406 is currently set to “do not perform printing”, the document generation application 315 does not output any annotation.

Similarly, in a case where the “form printing” 407, which is used to set whether to print a form in PDF, is currently set to “perform printing”, the document generation application 315 also outputs a form. In a case where the “form printing” 407 is currently set to “do not perform printing”, the document generation application 315 does not output any form.

Next, in step S315, the print setting enhancement application 312 generates “print data” and “print capability information” based on the “intermediate data” and “print setting information” received from the OS 313.

Furthermore, in FIG. 3B, step S315 is described only as “generate print data”.

Then, in step S316, the print setting enhancement application 312 sends the generated “print data” and “print capability information” to a print queue in the OS 313. Thus far is the processing details of the first pattern.

Next, a case where the print setting enhancement application 312 which is associated with a currently selected print queue is not currently installed, i.e., the second pattern, is described.

In step S317, the OS 313 transmits intermediate data and print setting information to the cloud printer driver 311. In step S318, the cloud printer driver 311 converts data output by the document generation application 315 into “intermediate data”, and generates “print data” and “print capability information” based on the “intermediate data” and the “print setting information”. Furthermore, step S318 illustrated in FIG. 3B is described as “generate print data”, “print capability information” is also generated.

In a case where, in a print setting initial screen illustrated in FIG. 4 which the document generation application 315 displays, the “annotation printing” 406, which is used to set whether to print an annotation in PDF, is currently set to “perform printing”, the document generation application 315 also outputs an annotation. In a case where the “annotation printing” 406 is currently set to “do not perform printing”, the document generation application 315 does not output any annotation.

Similarly, in a case where the “form printing” 407, which is used to set whether to print a form in PDF, is currently set to “perform printing”, the document generation application 315 also outputs a form. In a case where the “form printing” 407 is currently set to “do not perform printing”, the document generation application 315 does not output any form.

The third pattern is a case where the print setting enhancement application 312 which is associated with a currently selected print queue is previously installed on the client terminal 101 and the setting of the “PDF passthrough” is currently set to “enabled”. Furthermore, “PDF passthrough” is able to be set to “enabled” only in a case where the document generation application 315 is able to output a PDF file.

The OS 313 receives a PDF file and print setting information from the document generation application 315. In step S319, the OS 313 sends the received PDF file and print setting information to the print setting enhancement application 312. Furthermore, step S319 illustrated in FIG. 3B is described as “pass PDF file”. Next, in step S320, the print setting enhancement application 312 keeps the received PDF file unchanged and generates “print capability information” based on the received print setting information. The print setting enhancement application 312 transmits the PDF file and the generated “print capability information” to the OS 313. The generated “print capability information” also includes “annotation printing” 804, which indicates whether to print an annotation, and “form printing” 805, which indicates whether to print a form. Furthermore, step S320 illustrated in FIG. 3B is described only as “pass PDF file to OS”.

As mentioned above, in the case of the first pattern, processing operations in steps S314, S315, and S316 are performed so that rendering is performed by the print setting enhancement application 312. Moreover, in the case of the second pattern, processing operations in steps S317 and S318 are performed so that rendering is performed by the cloud printer driver 311.

Then, in the case of the third pattern, processing operations in steps S319 and S320 are performed so that PDF passthrough is performed.

Next, in step S321, the OS 313 transmits the print data and “print capability information” received from the print setting enhancement application 312 or the cloud printer driver 311 to the cloud print service 321. Then, in step S322, the cloud print service 321 transmits the print data and “print capability information” received from the client terminal 101 to the cloud print compatible printer 104.

Then, in the case of PDF passthrough, the cloud print compatible printer 104 controls whether to draw an annotation or form, based on information included in the “print capability information”.

Furthermore, the cloud print compatible printer 104 can be configured to periodically make an inquiry to the cloud print service 321 and thus acquire unprinted print data held on the cloud print service 321 and “print capability information” corresponding to the print data. Moreover, while, in the processing operation in step S301 illustrated in FIG. 3A, the document generation application 315 performs operations including acquisition of “capability information” through displaying of the print setting screen at timing when a printer name has been selected, the above-mentioned processing operations can be configured to be started at other timing. For example, the above-mentioned processing operations can be started at timing when the object 404 displayed on the document generation application 315 has been selected and operated.

The processing operations described so far are the entirety of print processing which has been performed using the print setting enhancement application 312. In the following description, “PDF passthrough” is described in detail.

In the first exemplary embodiment, in the case of “PDF passthrough” being performed, addition processing for an annotation or form is performed on the side of the cloud print compatible printer 104.

First, in the print setting screen which the print setting enhancement application 312 displays, setting as to whether to print an annotation or form is performed. The setting information and a PDF file created by the document generation application 315 and kept without being converted are transmitted to the cloud print compatible printer 104. Then, based on the setting information, whether to print an annotation or form is controlled on the side of the cloud print compatible printer 104.

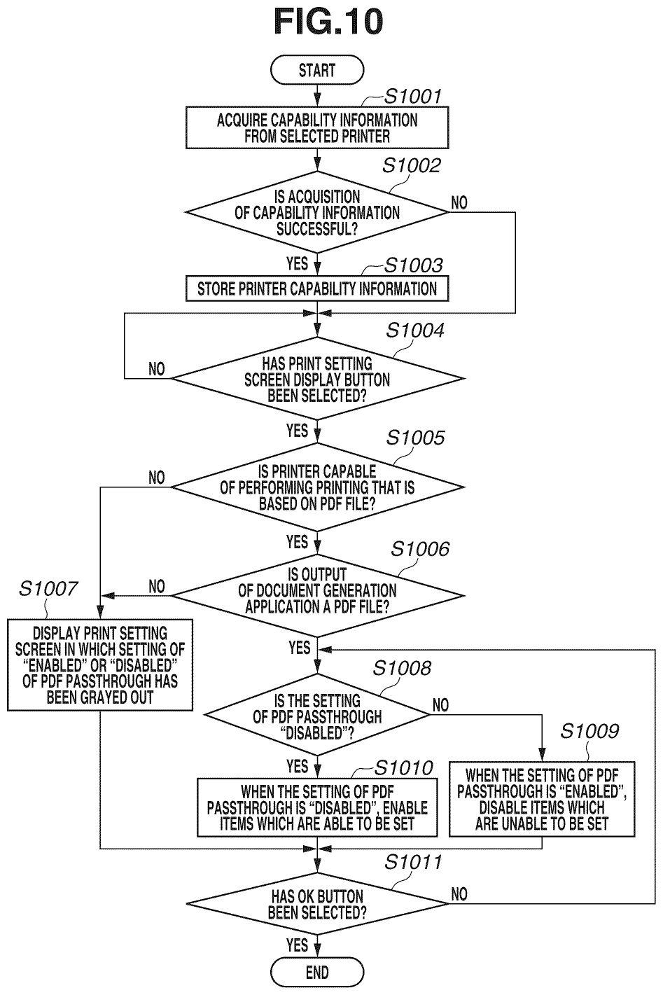

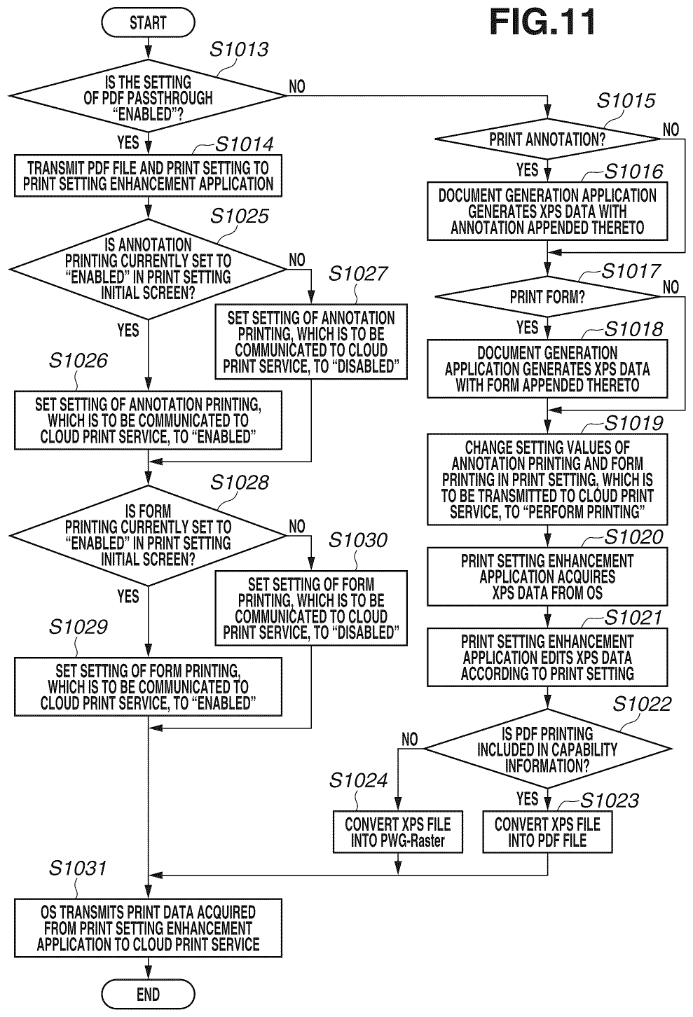

FIG. 10 and FIG. 11 are flowcharts illustrating processing which the client terminal 101 performs in the first exemplary embodiment. FIG. 10 is a flowchart illustrating processing which the print setting enhancement application 312 performs to display a print setting screen and receive print setting. This processing is implemented by a program stored in the memory 213 illustrated in FIG. 2A being loaded and the CPU 212 executing the loaded program. Specifically, the processing is implemented by the CPU 212 executing the print setting enhancement application 312.

The processing illustrated in FIG. 10 is started according to a print queue corresponding to the print setting enhancement application 312 being selected in the print setting screen (illustrated in FIG. 4) in the document generation application 315.

In step S1001, the CPU 212 transmits an acquisition request for capability information to the cloud print service 321 via the network 107. The acquisition request is performed with use of a Get-Printer-Attributes operation defined by the IPP, so that capability information is acquired about all of the setting items illustrated in FIG. 5.

In step S1002, the CPU 212 determines whether “capability information” has been able to be acquired.

If, in step S1002, it is determined that the print setting enhancement application 312 has been able to acquire “capability information” about a printer (YES in step S1002), the CPU 212 performs a processing operation in step S1003. In step S1003, the CPU 212 stores, in the storage unit 214, “capability information” about a printer associated with a print queue selected by the user.

On the other hand, if it is determined that the print setting enhancement application 312 has not been able to acquire “capability information” about a printer (NO in step S1002), the CPU 212 advances the processing to step S1004.

Next, in step S1004, the CPU 212 determines whether the object “other settings” 404 in the print setting screen illustrated in FIG. 4 has been selected. The CPU 212 performs a processing operation in step S1004 until the object “other settings” 404 is selected (NO in step S1004).

On the other hand, if it is determined that the object “other settings” 404 has been selected (YES in step S1004), the CPU 212 advances the processing to step S1005.

In response to the object “other settings” 404 being selected, a notification is sent from the document generation application 315 to the OS 313. Upon receiving the notification, the OS 313 selects the print setting enhancement application 312 associated with a print queue having the selected printer name, and causes the selected print setting enhancement application 312 to display an enhanced print setting screen.

In step S1005, the CPU 212 determines whether the printer having the selected printer name is capable of performing printing that is based on a PDF file, based on the device capability information associated with the print queue. Specifically, the CPU 212 refers to the device capability information and determines whether the cloud print compatible printer 104 supports a PDF file.

In a case where the cloud print compatible printer 104 is able to perform printing that is based on a PDF file (YES in step S1005), the CPU 212 performs a processing operation in step S1006. On the other hand, in a case where the cloud print compatible printer 104 is unable to perform printing that is based on a PDF file (NO in step S1005), the CPU 212 performs a processing operation in step S1007.

In step S1006, the CPU 212 determines whether a file which the document generation application 315 outputs is a PDF file. In step S1006, the print setting enhancement application 312 performs such determination based on, for example, whether a “character string” of “% PDF” is present at the head of a print file generated by the document generation application 315. Furthermore, the processing operation in step S1006 can be the following operation. The print setting enhancement application 312 acquires an “identifier” of the document generation application 315. The CPU 212 determines whether the “identifier” of the document generation application 315 acquired by the print setting enhancement application 312 is coincident with the “identifier” of a predetermined application. In a case where the “identifier” of the document generation application 315 is the predetermined identifier, the CPU 212 determines that the document generation application 315 outputs a PDF file (YES in step S1006), and advances the processing to step S1008. Furthermore, the “identifier” of an application which has instructed the print setting enhancement application 312 to display a print setting screen is acquired by using an application programming interface (API) which the OS 313 provides. On the other hand, if, in step S1006, it is determined that a file which the document generation application 315 outputs is not a PDF file (NO in step S1006), CPU 212 advances the processing to step S1007.

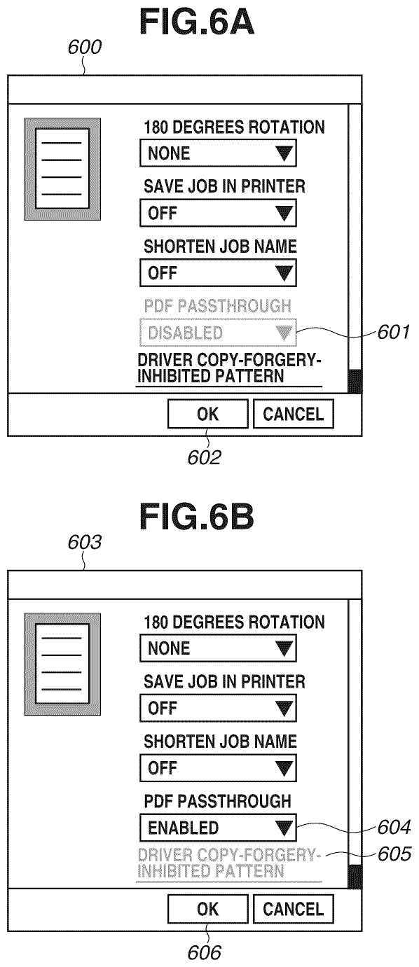

In step S1007, the CPU 212 displays a print setting screen in which a list box for setting “enabled” or “disabled” of PDF passthrough has been grayed out. In response to the processing operation in step S1007 being performed, a print setting screen 600 such as that illustrated in FIG. 6A is displayed. The print setting screen 600 includes an OK button 602 and a list box 601. The list box 601 is currently grayed out, so that the setting value is prevented from being changed from “disabled” to “enabled”. Moreover, each setting which is unable to be used in a case where the PDF passthrough setting is “enabled” is currently displayed in such a way as to be able to be operated. In step S1007, a setting item concerning PDF passthrough can be hidden.

In step S1008, the CPU 212 determines whether the setting of “PDF passthrough” is “disabled”. The CPU 212 acquires the current print setting information from the OS 313. The default value of the setting of PDF passthrough is a value designated by the capability information illustrated in FIG. 5. If it is determined that the setting of “PDF passthrough” is “disabled” (YES in step S1008), CPU 212 advances the processing to step S1010.

In step S1010, the CPU 212 displays a print setting screen in which the setting of “PDF passthrough” is set to “disabled” and predetermined functions are able to be set. In step S1010, a print setting screen illustrated in FIG. 8D is displayed.

On the other hand, if, in step S1008, it is determined that PDF passthrough is set to “enabled” (NO in step S1008), the CPU 212 performs a processing operation in step S1009. In step S1009, the CPU 212 displays a print setting screen in which the setting of “PDF passthrough” is set to “enabled” and predetermined functions are grayed out. In step S1009, a print setting screen 603 illustrated in FIG. 6B is displayed. The print setting screen 603 includes an OK button 606. In the print setting screen 603 illustrated in FIG. 6B, while “PDF passthrough” is displayed in such a way as to be set to “enabled” (in a list box 604), “driver copy-forgery-inhibited pattern” is displayed in such a way as to be grayed out (in an object 605).

Next, in step S1011, the print setting enhancement application 312 determines whether the OK button 802 has been selected. If it is determined that the OK button 802 has not been selected (NO in step S1011), the print setting enhancement application 312 returns the processing to step S1008. In the processing operations in steps S1008 to S1011, in a case where the setting of “PDF passthrough” is still not changed, the print setting enhancement application 312 does not perform changing of displaying concerning PDF passthrough. In a case where the user has changed the setting of “PDF passthrough”, the print setting enhancement application 312 performs the processing operation in step S1010 or S1009 in conformity with such changing.

If, in step S1011, it is determined by the print setting enhancement application 312 that the OK button 802 has been selected (YES in step S1011), the print setting enhancement application 312 transmits the current print setting information to the OS 313, and then ends displaying of the print setting screen. This causes the screen illustrated in FIG. 4 to be displayed. Furthermore, here, a print setting initial screen in which the print setting set via the print setting screen which the print setting enhancement application 312 provides has been reflected is displayed.

FIG. 11 is a flowchart illustrating processing which is performed when an instruction for starting printing has been issued in the print setting initial screen. Processing operations in the respective steps illustrated in FIG. 11 are implemented by the CPU 212 executing a program for any one of the OS 313, the document generation application 315, and the print setting enhancement application 312.

In step S1013, the OS 313 acquires the print setting and determines whether the setting of “PDF passthrough” is “enabled”. If it is determined by the OS 313 that the setting of “PDF passthrough” is “enabled” (YES in step S1013), the OS 313 advances the processing to step S1014. If it is determined by the OS 313 that the setting of “PDF passthrough” is “disabled” (NO in step S1013), the OS 313 advances the processing to step S1015.

In step S1014, the OS 313 transmits, to the print setting enhancement application 312, a PDF file and print setting which the document generation application 315 has output. More specifically, the OS 313 writes a PDF file and print setting which the document generation application 315 has output into a region from which the print setting enhancement application 312 is able to perform readout. Furthermore, at this time, the OS 313 performs transmission to the print setting enhancement application 312 directly without changing the content of a PDF file received from the document generation application 315.

In step S1025, the CPU 212 determines whether annotation printing is currently set to “enabled” in the print setting initial screen, according to the program for the print setting enhancement application 312. Specifically, the CPU 212 determines whether the “annotation printing” 406 illustrated in FIG. 4 is currently set to “perform printing”. If it is determined that annotation printing is currently set to “enabled” (YES in step S1025), then in step S1026, the CPU 212 sets the setting of annotation printing, which is to be communicated to the cloud print service 321, to “enabled”, according to the program for the print setting enhancement application 312.

If it is determined that annotation printing is currently set to “disabled” (NO in step S1025), then in step S1027, the CPU 212 sets the setting of annotation printing, which is to be communicated to the cloud print service 321, to “disabled”, according to the program for the print setting enhancement application 312.

In step S1028, the CPU 212 determines whether form printing is currently set to “enabled” in the print setting initial screen, according to the program for the print setting enhancement application 312. Specifically, the CPU 212 determines whether the “form printing” 407 illustrated in FIG. 4 is currently set to “perform printing”. If it is determined that form printing is currently set to “enabled” (YES in step S1028), then in step S1029, the CPU 212 sets the setting of form printing, which is to be communicated to the cloud print service 321, to “enabled”, according to the program for the print setting enhancement application 312. If it is determined that form printing is currently set to “disabled” (NO in step S1028), then in step S1030, the CPU 212 sets the setting of form printing, which is to be communicated to the cloud print service 321, to “disabled”, according to the program for the print setting enhancement application 312.

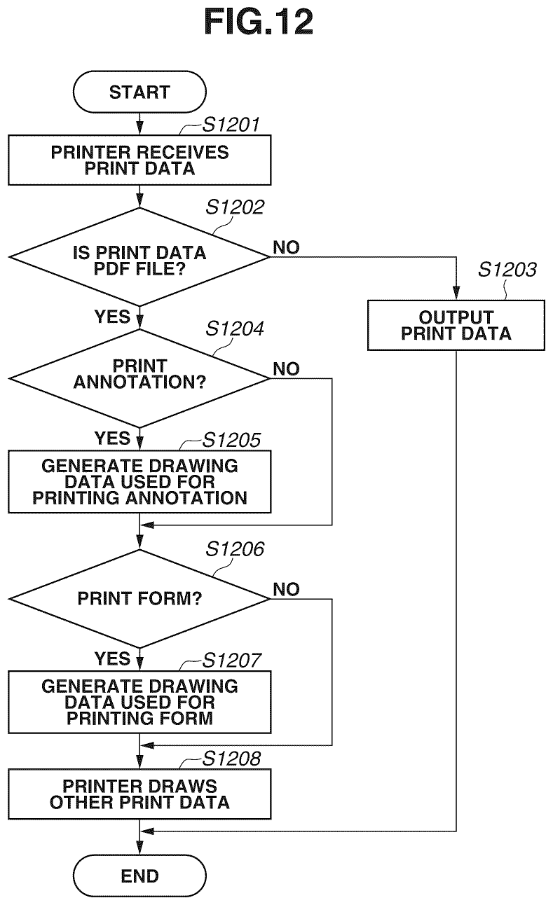

Furthermore, in a system for “PDF passthrough”, whether to print an annotation or form in PDF is controlled on the side of the cloud print compatible printer 104. This control is described below with reference to FIG. 12.

As also described in the description of the related art of the present specification, in the case of a system in which “PDF passthrough” is not performed, i.e., in the case of printing using a general-purpose printer driver, the document generation application 315 is able to control whether to print an annotation or form. While creating an XPS file via the OS 313, the document generation application 315 is able to control whether to cause an annotation or form to be included in the XPS file. This control is described in detail with regard to step S1015 and subsequent steps.

However, in the case of a system in which “PDF passthrough” is performed, the original data of the PDF format is directly transmitted to the cloud print compatible printer 104 without being converted into data of the XPS format. Thus, it is impossible that the document generation application 315 controls whether to print an annotation or form. Therefore, whether to print an annotation or form in PDF is controlled on the side of not the document generation application 315 but the cloud print compatible printer 104.

Next, operations which are performed in a case where “PDF passthrough” is currently set to “disabled” are described.

In step S1015, the CPU 212 determines whether the “annotation printing” 406, which indicates whether to print an annotation, is currently set to “perform printing”, according to the program for the document generation application 315. Specifically, the CPU 212 determines whether to perform annotation printing, according to the setting value set in the “annotation printing” 406 illustrated in FIG. 4.

If, in step S1015, it is determined that the “annotation printing” 406 is currently set to “perform printing” (YES in step S1015), then in step S1016, the CPU 212 generates XPS data with an annotation appended thereto according to the program for the document generation application 315. When converting data of the PDF format into data of the XPS format via the OS 313, the document generation application 315 causes an annotation to be included in the data of the XPS format.

On the other hand, if, in step S1015, it is determined that the “annotation printing” 406 is currently set to “do not perform printing” (NO in step S1015), the CPU 212 advances the processing to step S1017.

Next, in step S1017, the CPU 212 determines whether the “form printing” 407, which indicates whether to print a form, is currently set to “perform printing”, according to the program for the document generation application 315. Specifically, the CPU 212 refers to the value set in the “form printing” 407 illustrated in FIG. 4 and determines whether to print a form.

If, in step S1017, it is determined that the “form printing” 407 is currently set to “perform printing” (YES in step S1017), then in step S1018, the CPU 212 generates XPS data with a form appended thereto according to the program for the document generation application 315. Thus, when converting data of the PDF format into data of the XPS format via the OS 313, the document generation application 315 causes a form to be included in the data of the XPS format.

On the other hand, if, in step S1017, it is determined that the “form printing” 407 is currently set to “do not perform printing” (NO in step S1017), the document generation application 315 does not perform generation of XPS data with a form appended thereto. Thus, when converting data of the PDF format into data of the XPS format via the OS 313, the document generation application 315 does not cause a form to be included in the data of the XPS format.

In step S1019, the CPU 212 sets setting values of annotation printing and form printing in the print setting, which are to be transmitted to the cloud print service 321, according to the program for the print setting enhancement application 312. In step S1019, the CPU 212 sets both annotation printing and form printing to “perform printing”. However, in a case where PDF passthrough is not used, since PDF data to be transmitted to the cloud print compatible printer 104 does not include an annotation or form, the value to be set in step S1019 can be any one of “perform printing” and “do not perform printing”.

Next, in step S1020, the CPU 212 receives and acquires XPS data obtained by conversion and print setting information from the OS 313, according to the program for the print setting enhancement application 312. At this time, the CPU 212 also receives print setting information from the document generation application 315 according to the program for the OS 313.

In step S1021, the CPU 212 edits XPS data with use of the received print setting information, according to the program for the print setting enhancement application 312. The data editing includes, for example, processing for converting data, such as adding a copy-forgery-inhibited pattern.

In step S1022, the CPU 212 refers to capability information corresponding to a currently selected print queue and determines whether PDF printing is included in the “capability information”, according to the program for the print setting enhancement application 312. Then, if it is determined that PDF printing is included in the “capability information” (YES in step S1022), then in step S1023, the CPU 212 generates a PDF file that is based on the XPS file, according to the program for the print setting enhancement application 312. On the other hand, if, in step S1022, it is determined that PDF printing is not included in the “capability information” (NO in step S1022), the CPU 212 performs a processing operation in step S1024 according to the program for the print setting enhancement application 312.

In step S1023, the CPU 212 converts the “XPS file” into a PDF file with use of an “API” which the OS 313 provides, according to the program for the print setting enhancement application 312. Moreover, the CPU 212 also converts the print setting information into “attribute values” which are defined by the “IPP”. Furthermore, in a case where an “attribute value” which is not defined by the “IPP” is included in the print setting information, conversion is not performed with respect to such “attribute value”.

If, in step S1022, it is determined that PDF printing is not included in the “capability information” (NO in step S1022), then in step S1024, the CPU 212 generates “PWG-Raster” according to the program for the print setting enhancement application 312. Specifically, the CPU 212 converts the “XPS file” into “PWG-Raster” with use of the API of the OS 313 according to the program for the print setting enhancement application 312. Furthermore, even in step S1024, as with step S1023, the CPU 212 converts the print setting information into “attribute values” which are defined by the “IPP”.

Then, in step S1031, the CPU 212 registers the generated print data and print setting with a print queue according to the program for the print setting enhancement application 312. The OS 313 transmits the registered image data and print setting to the cloud print service 321 according to the “IPP”. Thus, the OS 313 transmits print data acquired from the print setting enhancement application 312 to the cloud print service 321.

The print data registered with the print queue is transmitted to the cloud print compatible printer 104 via the cloud print service 321.

The cloud print compatible printer 104 controls whether to print an annotation or form. The details of this control are described next.

FIG. 12 is a flowchart illustrating an example of processing which the cloud print compatible printer 104 performs upon receiving print data. The processing illustrated in FIG. 12 is implemented by the CPU 242 executing a program stored in the storage unit 244.

In step S1201, the CPU 242 causes the cloud print compatible printer 104 to receive print data.

Next, in step S1202, the CPU 242 determines whether the print data is a PDF file. If it is determined that the print data is a PDF file (YES in step S1202), the CPU 242 performs a processing operation in step S1204. On the other hand, if it is determined that the print data is not a PDF file (NO in step S1202), the CPU 242 performs a processing operation in step S1203.

In step S1204, the CPU 242 determines whether to print an annotation in PDF. The CPU 242 refers to the value which has been set in any one of steps S1026, S1027, and S1019 illustrated in FIG. 11.

If it is determined to print an annotation in PDF (YES in step S1204), the CPU 242 performs a processing operation in step S1205. If it is determined not to print an annotation in PDF (NO in step S1204), the CPU 242 advances the processing to step S1206 without performing step S1205. The CPU 242 reads a setting indicating whether to print an annotation included in the print setting in the print data, thus determining whether to print an annotation in PDF.

In step S1205, the CPU 242 generates drawing data used for printing an annotation in PDF. For example, the CPU 242 convers a character string described as an annotation in PDF into a text object, thus generating drawing data. The drawing data is, for example, bit-mapped data. In this way, the CPU 242 generates drawing data used for printing an annotation. Furthermore, in a case where, in step S1205, even when an instruction for printing an annotation has been issued, it is determined that there is no annotation in PDF, a processing operation concerning printing of an annotation is not performed.

In step S1206, the CPU 242 determines whether to print a form in PDF. The CPU 242 refers to the value which has been set in any one of steps S1029, S1030, and S1019 illustrated in FIG. 11.

If it is determined to print a form in PDF (YES in step S1206), the CPU 242 performs a processing operation in step S1207. If it is determined not to print a form in PDF (NO in step S1206), the CPU 242 performs a processing operation in step S1208 without performing a processing operation in step S1207.

The CPU 242 reads a setting indicating whether to print a form included in the print setting in the print data, thus determining whether to print a form in PDF.

In step S1207, the CPU 242 generates drawing data used for printing a form in PDF. For example, the CPU 242 generates data used for drawing an object corresponding to the form according to information about the form included in a PDF file. Furthermore, even in a case where it is determined by the CPU 242 to print a form, when there is no data concerning a form in PDF, a processing operation concerning printing of a form is not performed.

Next, in step S1208, the CPU 242 outputs a portion other than an annotation and form in PDF (for example, a text).

Thus far is the processing which is performed in a case where the CPU 242 has determined that the print data is a PDF file.

On the other hand, if it is determined that the print data is not a PDF file, then in step S1203, the CPU 242 outputs the print data.

In the above-described way, a series of processing operations illustrated in FIG. 10, FIG. 11, and FIG. 12 ends. With this series of processing operations, in the case of not performing “PDF passthrough” (in the case of performing printing using a “general-purpose printer driver”), as with background art, the document generation application 315 controls whether to print an annotation or form.

On the other hand, in the case of performing “PDF passthrough”, the side of the document generation application 315 does not control whether to print an annotation or form. Data of the PDF format is transmitted to the cloud print compatible printer 104 without being subjected to conversion. Then, the side of the cloud print compatible printer 104 controls whether to print an annotation or form. Thus, even in the case of performing “PDF passthrough”, finally, whether to print an annotation or form becomes able to be controlled.

Furthermore, in the first exemplary embodiment, the case of transmitting print data to the cloud print compatible printer 104 via the cloud print service 321 has been described as an example. A configuration in which the client terminal 101 and a printer connect directly to each other and a local printer driver which is provided by the OS of the client terminal 101 performs processing instead of the cloud printer driver 311 can be employed.

In this case, the operations which the cloud print service 321 performs illustrated in FIGS. 3A and 3B come to be performed by the printer.

Moreover, in the first exemplary embodiment, an example of using the setting values set via the settings 406 and 407 in the print setting initial screen in preference to the settings 804 and 805 in the print setting screen which the print setting enhancement application 312 provides has been described. The setting values set via the settings 804 and 805 in the print setting screen which the print setting enhancement application 312 provides can be prioritized over the setting values set via the settings 406 and 407 in the print setting initial screen. In that case, the CPU 212 refers to the setting values illustrated in FIGS. 8A to 8F in steps S1025, S1028, S1015, and S1017 illustrated in FIG. 11.

In the first exemplary embodiment, a configuration in which, in the case of “PDF passthrough” being performed, a setting as to whether to print an annotation or form is performed via the print setting screen which the print setting enhancement application 312 displays has been described. Additionally, a system in which such setting information is transmitted to the cloud print compatible printer 104 and whether to print an annotation or form is switched on the side of the cloud print compatible printer 104 has been described.

A second exemplary embodiment of the present disclosure is characterized in that, in a case where not to print an annotation or form has been set, a PDF file in which an annotation or form not to be printed has been deleted is generated by the document generation application 315. This enables controlling printing of an annotation or form at the time of “PDF passthrough” even in a case where the function of controlling whether to print an annotation or form is not mounted in the cloud print compatible printer 104.

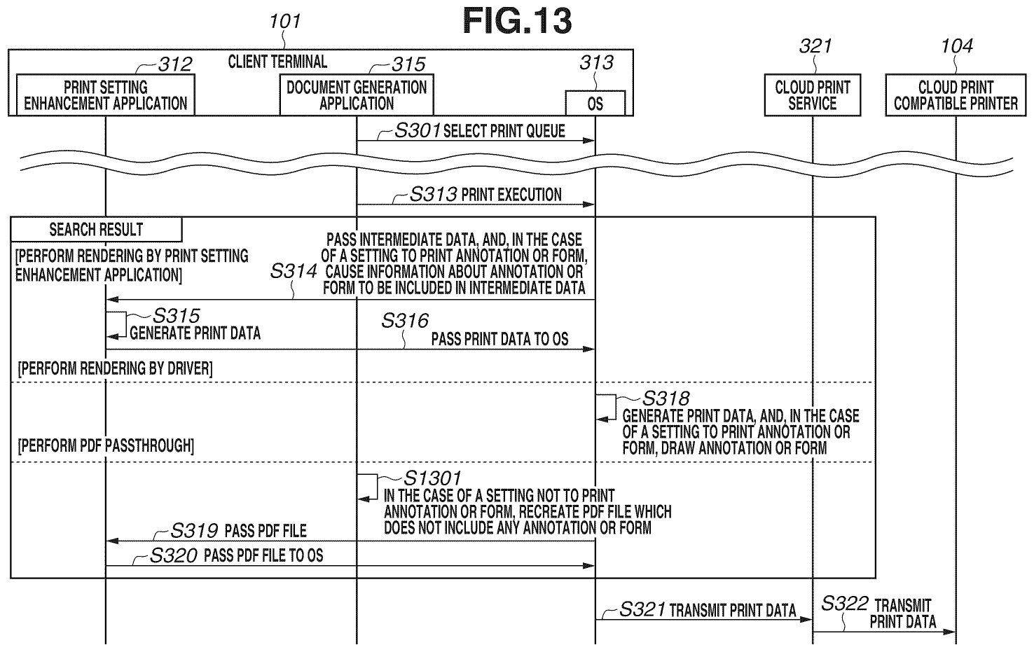

Processing which is performed in the second exemplary embodiment is described with reference to FIG. 13. Processing operations in steps S301 to S318 illustrated in FIG. 13 are similar to those illustrated in FIGS. 3A and 3B in the first exemplary embodiment. Therefore, the description of such processing operations is omitted here.

In step S1301, in the case of a setting not to print an annotation or form, the document generation application 315 creates a PDF file which does not include any annotation or form. Specifically, in a case where the “annotation printing” 406, which is used to set whether to print an annotation in PDF, is currently set to “do not perform printing”, the document generation application 315 creates a PDF file in which an annotation has been deleted. Similarly, in a case where the “form printing” 407, which is used to set whether to print a form in PDF, is currently set to “do not perform printing”, the document generation application 315 creates a PDF file in which a form has been deleted.

In step S319, the OS 313 passes a PDF file recreated in step S1301 and not including any annotation or form to the print setting enhancement application 312.

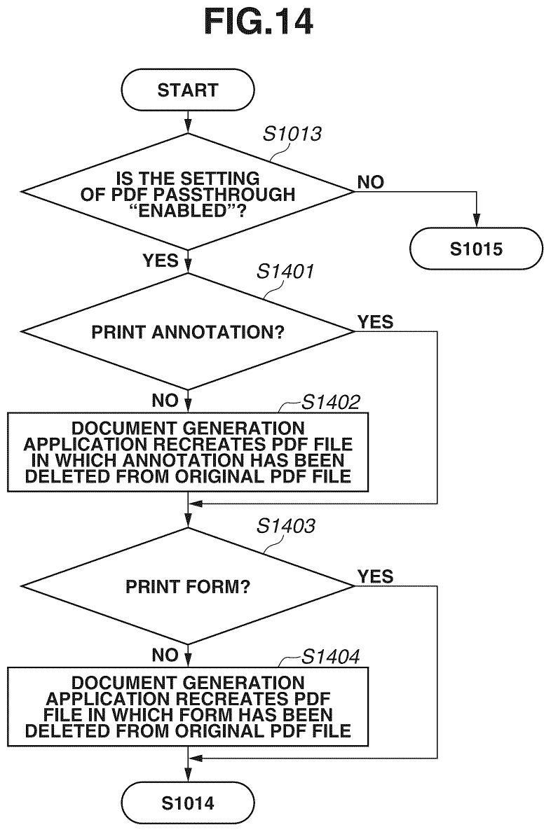

Next, an example of processing which is performed in the second exemplary embodiment is described with reference to FIG. 14. Processing operations in the respective steps illustrated in FIG. 14 are implemented by the CPU 212 executing a program for any one of the OS 313, the document generation application 315, and the print setting enhancement application 312.

In step S1013, the CPU 212 determines whether PDF passthrough is currently set to “enabled”, according to the program for the document generation application 315. If it is determined that PDF passthrough is currently set to “disabled” (NO in step S1013), the CPU 212 advances the processing to step S1015 illustrated in FIG. 11. Processing operations in step S1015 and subsequent steps are similar to those illustrated in FIG. 11.

If, in step S1013, it is determined that PDF passthrough is currently set to “enabled” (YES in step S1013), then in step S1401, the CPU 212 determines whether a setting to print an annotation is currently made, according to the program for the document generation application 315. The CPU 212 refers to the value set via the “annotation printing” 406 and performs such determination. If it is determined that a setting to print an annotation is currently made (YES in step S1401), since recreation of a PDF file is unnecessary, the CPU 212 advances the processing to step S1403. If it is determined that a setting not to print an annotation is currently made (NO in step S1401), the CPU 212 advances the processing to step S1402.

In the case of not printing an annotation (NO in step S1401), then in step S1402, the CPU 212 creates a PDF file in which an annotation has been deleted from a PDF file targeted for printing, according to the program for the document generation application 315. Thus, in a case where a setting not to print an annotation is currently made, the document generation application 315 creates a PDF file in which an annotation has been deleted. The document generation application 315 transmits the PDF file in which an annotation has been deleted to the cloud print compatible printer 104 according to the system for PDF passthrough. The cloud print compatible printer 104 prints the PDF file in which an annotation has been deleted. This enables controlling whether to print an annotation even in a case where the function of controlling whether to print an annotation is not provided on the side of the cloud print compatible printer 104 and in the system for PDF passthrough.

Next, in step S1403, the CPU 212 determines whether a setting to print a form is currently made, according to the program for the document generation application 315. The CPU 212 determines whether a setting to print a form is currently made based on the value set via the “form printing” 407.

In the case of not printing a form (NO in step S1403), then in step S1404, the CPU 212 creates a PDF file in which a form has been deleted from a PDF file targeted for printing, according to the program for the document generation application 315. The reason for this is similar to that in the above-mentioned case of not printing an annotation. On the other hand, in the case of printing a form (YES in step S1403), the CPU 212 skips step S1404.

Furthermore, for ease of explanation, an example in which processing operations are divided between step S1402 and step S1404 has been described. In actual processing, step S1402 and step S1404 can be performed at the same time. Thus, the CPU 212 can be configured to create a PDF file in which an annotation and a form have been deleted at a time.

After performing a processing operation in step S1404, the CPU 212 advances the processing to step S1014 illustrated in FIG. 11. Processing operations in step S1014 and subsequent steps are similar to those in the first exemplary embodiment.

Thus, the processing illustrated in FIG. 14 ends. This enables controlling printing of an annotation or form at the time of “PDF passthrough” even in a case where the function of controlling whether to print an annotation or form is not mounted in the cloud print compatible printer 104.

Furthermore, in the second exemplary embodiment, the setting value in annotation printing or form printing which is set by the document generation application 315 is prioritized over the setting value in annotation printing or form printing which is set via the print setting screen of the print setting enhancement application 312. The setting value in annotation printing or form printing which is set via the print setting screen of the print setting enhancement application 312 can be configured to be prioritized over the setting value in annotation printing or form printing which is set by the document generation application 315.

In the second exemplary embodiment, a configuration in which the document generation application 315 recreates a PDF file which does not include any annotation or form has been described.

In a third exemplary embodiment of the present disclosure, a configuration in which, in a case where PDF passthrough is currently set to “enabled” and a setting not to print an annotation or form is currently made, the print setting enhancement application 312 recreates a PDF file which does not include any annotation or form is described. This enables controlling printing of an annotation or form at the time of “PDF passthrough” even in a case where the function of controlling whether to print an annotation or form is not mounted in the cloud print compatible printer 104 and the document generation application 315.

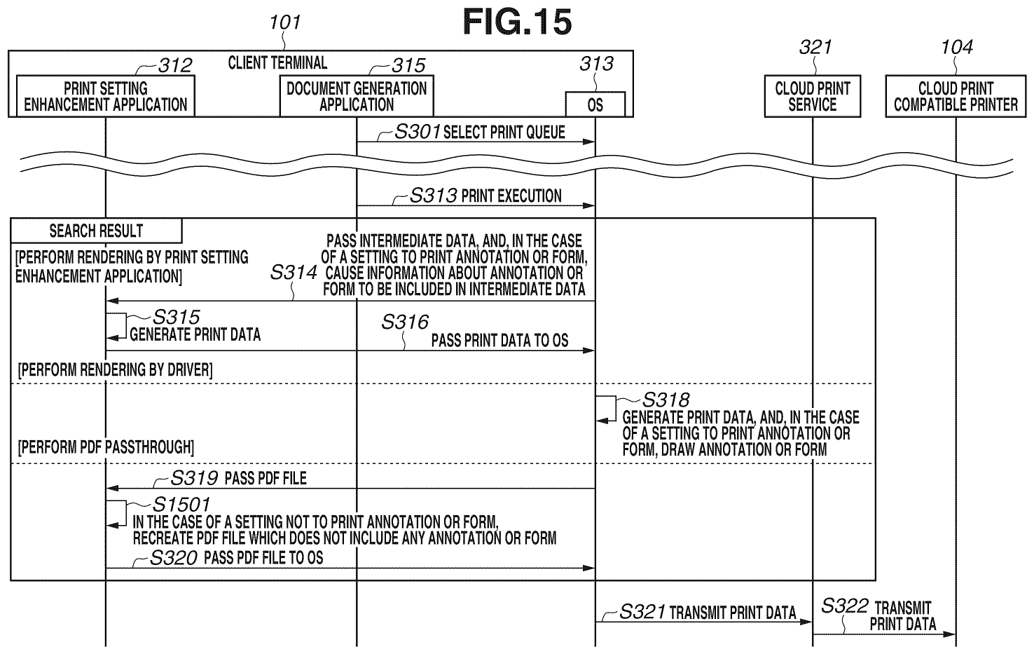

First, processing which is performed in the third exemplary embodiment is described with reference to FIG. 15. Processing operations in steps S301 to S318 illustrated in FIG. 15 are similar to those illustrated in FIGS. 3A and 3B in the first exemplary embodiment. Therefore, the description of such processing operations is omitted here.

In step S319, the OS 313 sends the received PDF file and print setting information to the print setting enhancement application 312.

In step S1501, in the case of a setting not to print an annotation or form, the print setting enhancement application 312 creates a PDF file which does not include any annotation or form. Specifically, in a case where the “annotation printing” 406, which is used to set whether to print an annotation, is currently set to “do not perform printing” in the print setting initial screen of the document generation application 315, the print setting enhancement application 312 creates a PDF file in which an annotation has been deleted. Similarly, in a case where the “form printing” 407, which is used to set whether to print a form, is currently set to “do not perform printing”, the print setting enhancement application 312 creates a PDF file in which a form has been deleted.

In step S320, the print setting enhancement application 312 passes a PDF file which does not include any annotation or form, recreated in step S1501, to the OS 313.

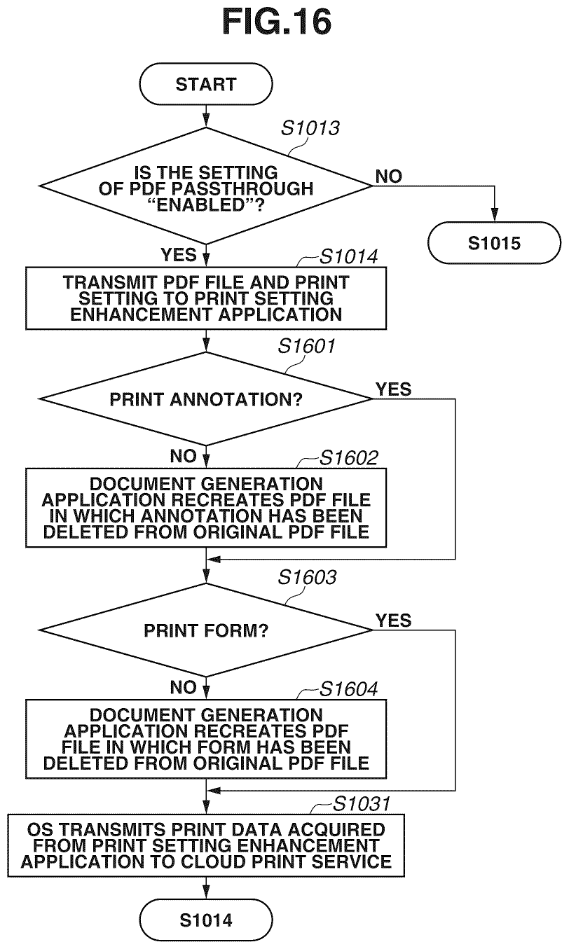

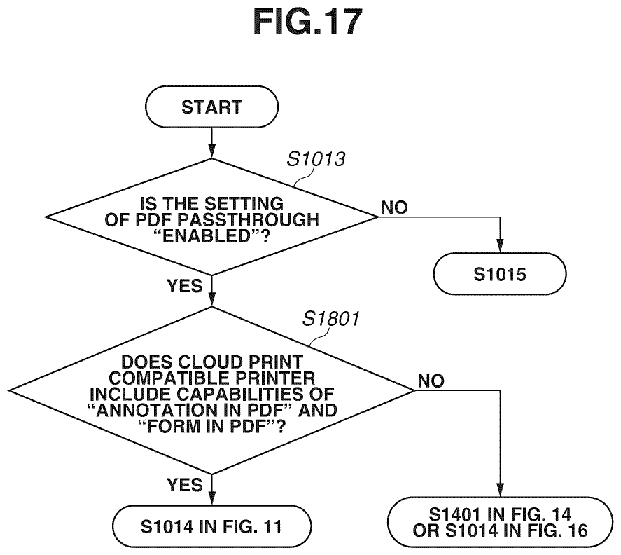

Next, an example of processing which is performed in the third exemplary embodiment is described with reference to FIG. 16. Processing operations in the respective steps illustrated in FIG. 16 are implemented by the CPU 212 executing a program for any one of the OS 313, the document generation application 315, and the print setting enhancement application 312.

In step S1013, the CPU 212 determines whether PDF passthrough is currently set to “enabled”, according to the program for the document generation application 315.

If it is determined that PDF passthrough is currently set to “enabled” (YES in step S1013), then in step S1014, the CPU 212 sends the received PDF file and print setting information to the print setting enhancement application 312 according to the program for the OS 313.

Next, in step S1601, the CPU 212 determines whether a setting to print an annotation is currently made, according to the program for the print setting enhancement application 312. The CPU 212 refers to the setting value set via the “annotation printing” 406 of the print setting initial screen and performs such determination in step S1601.

In the case of not printing an annotation (NO in step S1601), then in step S1602, the CPU 212 creates a PDF file in which an annotation has been deleted from a PDF file targeted for printing, according to the program for the print setting enhancement application 312.

In a case where a setting not to print an annotation is currently made, the CPU 212 creates a PDF file in which an annotation has been deleted, according to the program for the print setting enhancement application 312. The PDF file in which an annotation has been deleted is transmitted to the cloud print compatible printer 104 according to the system for PDF passthrough. The cloud print compatible printer 104 prints the received PDF file in which an annotation has been deleted. This enables controlling annotation printing, without recourse to a printer, in the system for PDF passthrough even in a case where the function of recreating a PDF file in which an annotation has been deleted is not provided on the side of the document generation application 315 as in the second exemplary embodiment. On the other hand, in the case of printing an annotation (YES in step S1601), the CPU 212 skips step S1602.

Next, in step S1603, the CPU 212 determines whether a setting to print a form is currently made, according to the program for the print setting enhancement application 312.

In the case of not printing a form (NO in step S1603), then in step S1604, the CPU 212 creates a PDF file in which a form has been deleted from a PDF file targeted for printing, according to the program for the print setting enhancement application 312. On the other hand, in the case of printing a form (YES in step S1603), the CPU 212 skips step S1604.

Furthermore, for ease of explanation, an example in which processing operations are divided between step S1602 and step S1604 has been described. In actual processing, step S1602 and step S1604 can be performed at the same time. Thus, the CPU 212 can be configured to create a PDF file in which an annotation and a form have been deleted at a time.

A processing operation in step S1031 is similar to that in the first exemplary embodiment and is, therefore, omitted from description here.

Thus, the processing illustrated in FIG. 16 ends. This enables controlling printing of an annotation or form at the time of “PDF passthrough” even in a case where the function of controlling whether to print an annotation or form is not mounted in the cloud print compatible printer 104 and the document generation application 315.

In the third exemplary embodiment, a configuration in which the print setting enhancement application 312 recreates a PDF file which does not include any annotation or form has been described.

In a fourth exemplary embodiment of the present disclosure, the configuration of switching between processing in the first exemplary embodiment, processing in the second exemplary embodiment, and processing in the third exemplary embodiment according to capability information acquired from the cloud print compatible printer 104 is described. With this configuration, in a case where the function of controlling whether to print an annotation or form is mounted in the cloud print compatible printer 104, a PDF file is not recreated by the client terminal but transmitted to the cloud print compatible printer 104. On the other hand, only in a case where the function of controlling whether to print an annotation or form is not mounted in the cloud print compatible printer 104, a PDF file corresponding to the print setting for an annotation or form is created by the client terminal.

Next, an example of processing which is performed in the fourth exemplary embodiment is described with reference to FIG. 17. Processing operations in the respective steps illustrated in FIG. 17 are implemented by the CPU 212 executing a program for any one of the OS 313, the document generation application 315, and the print setting enhancement application 312.

FIG. 17 illustrates processing which substitutes for that illustrated in FIG. 11 in the first exemplary embodiment.

In step S1013, the CPU 212 determines whether PDF passthrough is currently set to “enabled”, according to the program for the document generation application 315.

If, in step S1013, it is determined that PDF passthrough is currently set to “enabled” (YES in step S1013), the CPU 212 advances the processing to step S1801.

In step S1801, the CPU 212 determines whether the cloud print compatible printer 104 includes the capabilities of “annotation in PDF” 502 and “form in PDF” 503, according to the program for the print setting enhancement application 312.

If it is determined that the cloud print compatible printer 104 includes the above-mentioned capabilities (YES in step S1801), the CPU 212 performs processing operations in step S1014 and subsequent steps illustrated in FIG. 11. Processing operations in step S1014 and subsequent steps are similar to those in the first exemplary embodiment.

On the other hand, if it is determined that the cloud print compatible printer 104 does not include the above-mentioned capabilities (NO in step S1801), the CPU 212 advances the processing to step S1401 illustrated in FIG. 14 in the second exemplary embodiment or step S1014 illustrated in FIG. 16 in the third exemplary embodiment. Subsequent processing operations are similar to those in the second exemplary embodiment or the third exemplary embodiment.

Thus, the processing illustrated in FIG. 17 ends. With this processing, in a case where the function of controlling whether to print an annotation or form is mounted in the cloud print compatible printer 104, a PDF file is not recreated by the client terminal but transmitted to the cloud print compatible printer 104. On the other hand, only in a case where the function of controlling whether to print an annotation or form is not mounted in the cloud print compatible printer 104, a PDF file is created by the client terminal.

In the fourth exemplary embodiment, the configuration of switching between processing in the first exemplary embodiment, processing in the second exemplary embodiment, and processing in the third exemplary embodiment according to capability information acquired from the cloud print compatible printer 104 has been described.

In a fifth exemplary embodiment of the present disclosure, the configuration of disabling “PDF passthrough printing” in a case where the “annotation printing” 406 and “form printing” 407 in the print setting screen of the document generation application 315 are currently set to “do not perform printing” is described. This enables preliminarily preventing a situation in which, due to “PDF passthrough printing” being used, the setting for annotation printing or form printing has not been reflected in a printed result.

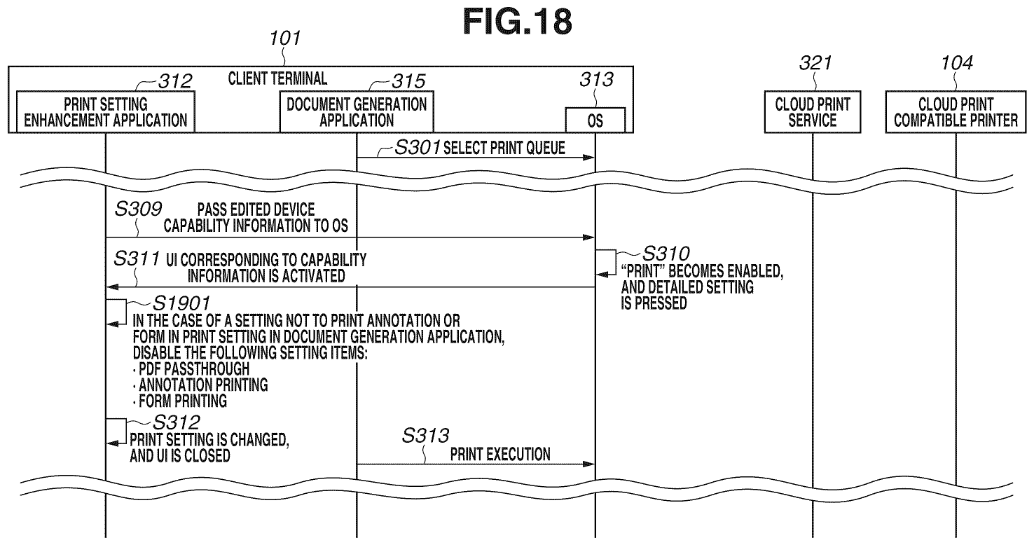

Processing which is performed in the fifth exemplary embodiment is described with reference to FIG. 18. Processing operations in steps S301 to S311 illustrated in FIG. 18 are similar to those illustrated in FIG. 3A in the first exemplary embodiment. Therefore, the description of such processing operations is omitted here.

In step S1901, the print setting enhancement application 312 determines whether the “annotation printing” 406 or “form printing” 407 is currently set to “do not perform printing” in the print setting in the document generation application 315. In a case where any one of the “annotation printing” 406 and “form printing” 407 is currently set to “do not perform printing”, the print setting enhancement application 312 sets the setting items for the “PDF passthrough” 803, “annotation printing” 804, and “form printing” 805 in the print setting screen which the print setting enhancement application 312 displays to “disabled”.

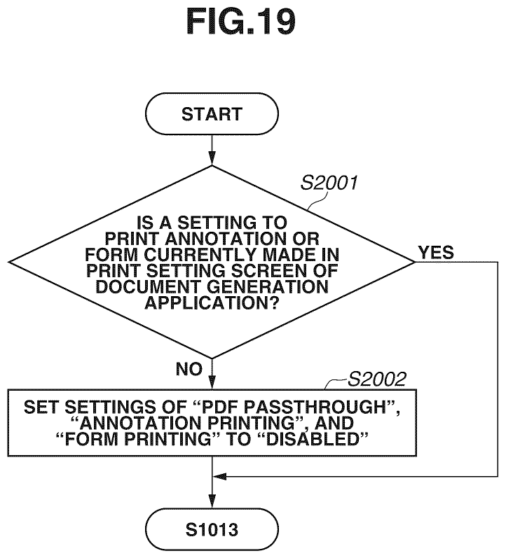

An example of processing which is performed in the fifth exemplary embodiment is described with reference to FIG. 19.

FIG. 19 illustrates processing which substitutes for that illustrated in FIG. 11 in the first exemplary embodiment. Processing operations in the respective steps illustrated in FIG. 19 are implemented by the CPU 212 executing a program for any one of the OS 313, the document generation application 315, and the print setting enhancement application 312.

In step S2001, the CPU 212 determines whether the “annotation printing” 406 or “form printing” 407 in the print setting screen of the document generation application 315 is currently set to “perform printing”, according to the program for the print setting enhancement application 312.

If it is determined that the “annotation printing” 406 or “form printing” 407 is currently set to “do not perform printing” (NO in step S2001), the CPU 212 performs a processing operation in step S2002. In step S2002, the CPU 212 sets the settings of the “PDF passthrough” 803, “annotation printing” 804, and “form printing” 805, which are set in the print setting screen of the print setting enhancement application 312, to “disabled”, according to the program for the print setting enhancement application 312.

If, in step S2001, it is determined that the “annotation printing” 406 and “form printing” 407 are currently set to “perform printing” (YES in step S2001), the CPU 212 skips step S2002.

The CPU 212 performs processing operations in step S1013 and subsequent steps illustrated in FIG. 11. Processing operations in step S1013 and subsequent steps are similar to those in the first exemplary embodiment and are, therefore, omitted from description here.

Thus, the processing illustrated in FIG. 19 ends. In a case where the “annotation printing” 406 and “form printing” 407 in the print setting screen of the document generation application 315 are currently set to “do not perform printing”, “PDF passthrough printing” is disabled. This has an advantageous effect of preliminarily preventing a situation in which, due to “PDF passthrough printing” being used, the setting for annotation printing or form printing has not been reflected in a printed result.

Furthermore, in the fifth exemplary embodiment, the configuration of setting three setting items for the “PDF passthrough” 803, “annotation printing” 804, and “form printing” 805 to “disabled” has been described. Since the “annotation printing” 804 and “form printing” 805 are setting values which are referred to when the “PDF passthrough” 803 is set to “enabled”, the configuration of changing only the “PDF passthrough” 803 to “disabled” can be employed.

In the fifth exemplary embodiment, the configuration of setting “PDF passthrough printing” to “disabled” in a case where the “annotation printing” 406 and “form printing” 407 in the print setting screen of the document generation application 315 are currently set to “do not perform printing” has been described.

In a sixth exemplary embodiment of the present disclosure, the settings of the “annotation printing” 406 and “form printing” 407 in the print setting screen of the document generation application 315 and the settings of the “annotation printing” 804 and “form printing” 805 in the print setting screen of the print setting enhancement application 312 are made to interlock with each other. This causes the settings of the document generation application 315 and the print setting enhancement application 312 to become equal to each other, so that the user's convenience is improved.

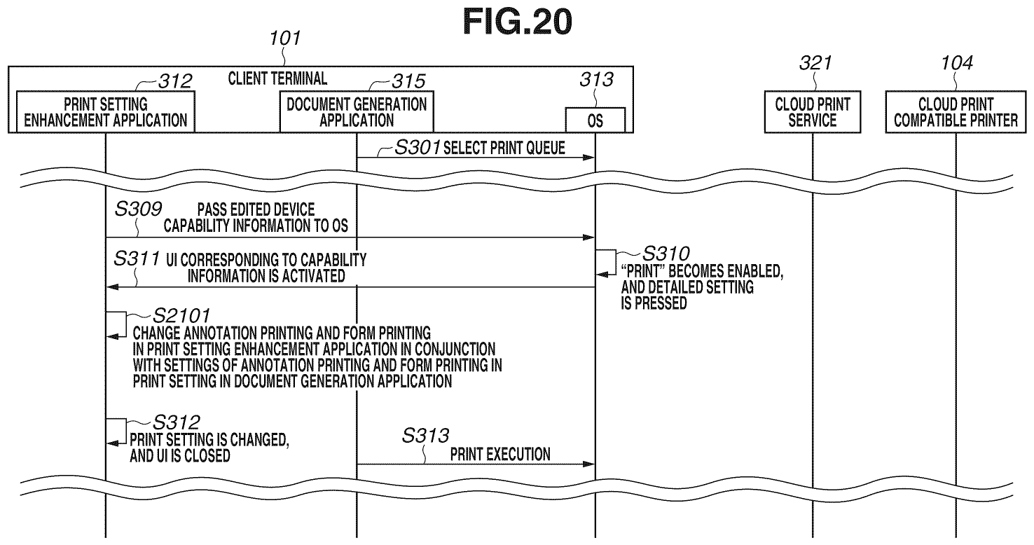

First, processing which is performed in the sixth exemplary embodiment is described with reference to FIG. 20. Processing operations in steps S301 to S311 illustrated in FIG. 20 are similar to those illustrated in FIG. 3A in the first exemplary embodiment. Therefore, the description of such processing operations is omitted here.

In step S2101, the print setting enhancement application 312 acquires the settings of the “annotation printing” 406 and “form printing” 407 in the print setting in the document generation application 315. Then, the print setting enhancement application 312 sets the acquired setting values to the “annotation printing” 804 and “form printing” 805 in the print setting screen which the print setting enhancement application 312 displays.

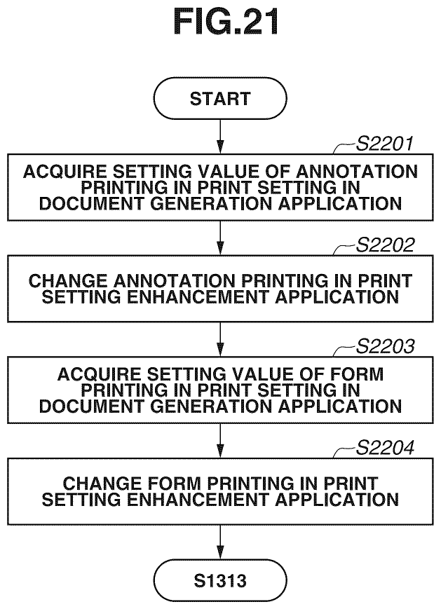

Next, an example of processing which is performed in the sixth exemplary embodiment is described with reference to FIG. 21. FIG. 21 is a flowchart illustrating the details of a processing operation in step S2101 illustrated in FIG. 20, and the processing operation is implemented by the CPU 212 executing a program for the print setting enhancement application 312.

In step S2201, the CPU 212 acquires the setting value of the “annotation printing” 406 in the print setting screen of the document generation application 315 according to the program for the print setting enhancement application 312.

Next, in step S2202, the CPU 212 sets the value acquired in step S2201 to the “annotation printing” 804 in the print setting screen of the print setting enhancement application 312 according to the program for the print setting enhancement application 312.

Next, in step S2203, the CPU 212 acquires the setting value of the “form printing” 407 in the print setting screen of the document generation application 315 according to the program for the print setting enhancement application 312.

Next, in step S2204, the CPU 212 sets the value acquired in step S2203 to the “form printing” 805 in the print setting screen of the print setting enhancement application 312 according to the program for the print setting enhancement application 312.

Processing operations which are performed after the print button of the document generation application 315 has been selected are similar to those in the first exemplary embodiment and are, therefore, omitted from description here.

Thus, the processing illustrated in FIG. 21 ends. This causes the settings of the document generation application 315 and the print setting enhancement application 312 to become equal to each other, so that the user's convenience is improved.

Furthermore, while, in the sixth exemplary embodiment, the configuration of causing the settings of the document generation application 315 and the print setting enhancement application 312 to interlock with each other has been described, a configuration in which whichever of the settings is preferentially used can be employed. Thus, a configuration in which the setting of the document generation application 315 is preferentially used can be employed. Similarly, a configuration in which the setting of the print setting enhancement application 312 is preferentially used can be employed.

In all of the thus far described exemplary embodiments, processing for transmitting a PDF file and print capability information, which the client terminal 101 has transmitted, to the cloud print compatible printer 104 via the cloud print service 321 has been described. However, embodiments of the present disclosure can also be applied to a case where the client terminal 101 and the cloud print compatible printer 104 are directly connected to each other without via the cloud print service 321.

Exemplary embodiments of the present disclosure can be implemented by performing the following processing. Thus, software (program) for implementing the above-described exemplary embodiments is supplied to a system or apparatus via a network or a recording medium. Then, a computer (specifically, a processor such as a CPU or micro processing unit (MPU)) of the system or apparatus reads out and executes program code. In this case, the computer program and the recording medium storing the computer program also serve as an objective of the present disclosure. Moreover, while, in the above-described exemplary embodiments, processing for performing communication of “capability information” and print data via the cloud print service 321 has been described, a configuration in which communication is performed directly with the cloud print compatible printer 104 can also be employed.

The configuration of transmitting print data created by the client terminal 101 “directly” to the cloud print compatible printer 104 without via, for example, the cloud print server 102 can also be employed.

In this case, for example, the client terminal 101 and the cloud print compatible printer 104 can be configured to be able to wirelessly communicate required information to each other.

Moreover, examples of the client terminal 101 to be used include, in addition to a personal computer (PC), mobile terminals such as a smartphone and a tablet terminal. For example, in the case of using a smartphone, a dedicated application for implementing the processing in each exemplary embodiment of the present disclosure can be downloaded from a specific web site and installed on the smartphone. At this time, in a case where the distance between the smartphone and the cloud print compatible printer 104 is relatively small, communication between them can be enabled by, for example, “Bluetooth®” Moreover, a configuration in which a mobile terminal connects to the Internet via a portable rechargeable Wi-Fi® router and a printing apparatus connects to the Internet via a wired or wireless router can be employed. To connect the printing apparatus to the router via wired connection, a configuration in which the printing apparatus is provided with a plug-in for a local area network (LAN) cable can be employed. Thus, the mobile terminal and the printing apparatus are connected to each other in such a way as to be able to communicate with each other via a network such as the Internet. Additionally, since a portable rechargeable Wi-Fi® router is used, the user is able to use the mobile terminal at a carrying destination to perform processing concerning each exemplary embodiment of the present disclosure.

Moreover, a display user interface (UI) can be displayed as a three-dimensional image so as to facilitate visual confirmation. In this case, the user wears, for example, goggles or special spectacles to visually check a three-dimensional image.

Moreover, in a case where print setting for “PDF passthrough” is performed, the corresponding portion can be highlighted to improve visibility, thus facilitating setting confirmation. While examples of the highlighting manner include color emphasis display, a highlighting manner for displaying a print setting portion of “PDF passthrough” in a larger size than those of the other setting items can be employed. Naturally, the highlighting manner is not limited to these.

In a case where print setting for “PDF passthrough” has been performed, a message indicating that effect can be displayed in a UI display screen, which pops up the message from the print setting and hides the message after a predetermined time, so as to facilitate the user to confirm the setting content.

According to embodiments of the present disclosure, even in the case of transmitting a file of a predetermined format which the application has output to a printing apparatus without changing the format of the file, it is possible to control whether to print an annotation in the file of the predetermined format.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random access memory (RAM), a read-only memory (ROM), a storage of distributed computing systems, an optical disk (such as a compact disc (CD), digital versatile disc (DVD), or Blu-ray Disc (BD)™M), a flash memory device, a memory card, and the like.

While the present disclosure includes exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-201642, filed Nov. 29, 2023, which is hereby incorporated by reference herein in its entirety.

What is claimed is:

1. A non-transitory computer-readable storage medium storing an application program which causes an information processing apparatus to perform a control method, the application program being configured to support a general-purpose printer driver stored in the information processing apparatus, the control method comprising:
setting a setting value of a first function which transmits a file of a predetermined format output by a document generation application to a printing apparatus without converting the format of the file;
setting a setting value of a second function which prints information appended with use of a predetermined function provided by the document generation application; and
in a case where the first function has been set enabled, causing print data generated based on the set setting value of the second function to be transmitted.

2. The non-transitory computer-readable storage medium according to claim 1, wherein the control method further comprises, in a case where the second function has been set disabled, causing the file of the predetermined format with the information generated by the document generation application not appended thereto to be transmitted as the print data.

3. The non-transitory computer-readable storage medium according to claim 1, wherein the control method further comprises:
in a case where the second function has been set disabled, based on the file of the predetermined format output by the document generation application, generating the file of the predetermined format with the information not added thereto; and
causing the generated file to be transmitted as the print data.

4. The non-transitory computer-readable storage medium according to claim 3, wherein the control method further comprises, based on capability information about the printing apparatus, determining whether to perform generating the file of the predetermined format with the information not added thereto.

5. The non-transitory computer-readable storage medium according to claim 1, wherein the control method further comprises, based on a setting value of a setting item concerning printing of the information set in a print setting screen provided by the document generation application being a predetermined value, setting the first function disabled.

6. The non-transitory computer-readable storage medium according to claim 1, wherein the control method further comprises:
acquiring a setting value of a setting item concerning printing of the information set in a print setting screen provided by the document generation application; and
based on the acquired setting value, setting a setting value of the second function.

7. The non-transitory computer-readable storage medium according to claim 1, wherein the predetermined format is Portable Document Format (PDF).

8. The non-transitory computer-readable storage medium according to claim 1, wherein the general-purpose printer driver is a driver provided by a vendor which provides an operating system of the information processing apparatus.

9. The non-transitory computer-readable storage medium according to claim 8, wherein the application program is provided by a vendor which provides the printing apparatus.

10. The non-transitory computer-readable storage medium according to claim 1, wherein the control method further comprises:
in a case where the first function is currently set disabled, receiving intermediate data that is based on a file output by the document generation application; and
causing print data that is based on data obtained by converting the intermediate data into the predetermined format to be transmitted.

11. The non-transitory computer-readable storage medium according to claim 10, wherein the intermediate data is XML Paper Specification (XPS) data.

12. A control method for an information processing apparatus which is implemented by executing a print setting application for enhancing a function of a general-purpose printer driver stored in the information processing apparatus, the control method comprising:
setting a setting value of a first function which transmits a file of a predetermined format output by a document generation application to a printing apparatus without converting the format of the file;
setting a setting value of a second function which prints information appended with use of a predetermined function provided by the document generation application; and
in a case where the first function has been set enabled, causing print data generated based on the set setting value of the second function to be transmitted.

13. An information processing apparatus storing a general-purpose printer driver and a print setting application for enhancing a function of the general-purpose printer driver, the information processing apparatus comprising:
a first setting unit configured to set a setting value of a first function which transmits a file of a predetermined format output by a document generation application to a printing apparatus without converting the format of the file;
a second setting unit configured to set a setting value of a second function which prints information appended with use of a predetermined function provided by the document generation application; and
a control unit configured to, in a case where the first function has been set enabled, cause print data generated based on the setting value set by the second setting unit to be transmitted.
